(19) United States
(12) Patent Application Publication
(10) Pub. No.: US 2020/0340208 A1
(43) Pub. Date: Oct. 29, 2020

(54) SHOVEL AND SHOVEL MANAGEMENT SYSTEM

(71) Applicant: SUMITOMO CONSTRUCTION MACHINERY CO., LTD., Tokyo (JP)

(72) Inventors: Daisuke KITAJIMA, Chiba (JP); Hiroyuki TSUKAMOTO, Chiba (JP)

(21) Appl. No.: 16/923,337

(22) Filed: Jul. 8, 2020

Related U.S. Application Data
(63) Continuation of application No. PCT/JP2019/000600, filed on Jan. 10, 2019.

(30) Foreign Application Priority Data
Jan. 10, 2018 (JP) 2018-001976

(51) Int. Cl. E02F 3/96; B66C 13/18; E02F 9/26; B66C 13/16; B66C 13/46; B66C 15/00; B66C 23/90; E02F 9/24; E02F 9/20; B66C 1/68; B66C 13/48; B66C 13/04

(52) U.S. Cl. CPC E02F 3/964; E02F 3/32; B66C 13/18; E02F 9/26; B66C 13/16; B66C 13/46; B66C 15/00; B66C 23/905; E02F 9/24; E02F 9/265; E02F 9/2041; B66C 1/68; B66C 13/48; B66C 13/04; E02F 3/962

(57) ABSTRACT

A shovel includes a lower traveling body, an upper turning body turnably mounted on the lower traveling body, an object monitoring device attached to the upper turning body, an attachment attached to the upper turning body, a hook attached to the attachment, and a hardware processor. The hardware processor is configured to switch the operating mode of the shovel to a crane mode based on information obtained by the object monitoring device.

### CROSS-REFERENCE TO RELATED APPLICATIONS

This application is a continuation application filed under 35 U.S.C. 111(a) claiming benefit under 35 U.S.C. 120 and 365(c) of PCT International Application No. PCT/JP2019/000600, filed on Jan. 10, 2019 and designating the U.S., which claims priority to Japanese patent application No. 2018-001976, filed on Jan. 10, 2018. The entire contents of the foregoing applications are incorporated herein by reference.

### BACKGROUND

### Technical Field

The present disclosure relates to shovels and shovel management systems.

### Description of Related Art

A shovel with a hook for performing crane work is known. This hook is stored in a storage part provided at a bucket link when excavation work is performed and is pulled out from the storage part and used when crane work is performed.

Furthermore, this shovel includes a proximity switch that detects the storage of the hook in order to prevent excavation work from being performed with the hook not stored in the storage part. This shovel is configured to restrict the movement of an attachment by switching the operating mode to a crane mode in response to determining that the hook is not stored in the storage part based on the output of the proximity switch.

### SUMMARY

According to an aspect of the present invention, a shovel includes a lower traveling body, an upper turning body turnably mounted on the lower traveling body, an object monitoring device attached to the upper turning body, an attachment attached to the upper turning body, a hook attached to the attachment, and a hardware processor. The hardware processor is configured to switch the operating mode of the shovel to a crane mode based on information obtained by the object monitoring device.

### BRIEF DESCRIPTION OF THE DRAWINGS

FIG. 1 is a side view of a shovel according to an embodiment of the present invention;

FIG. 2 is a block diagram illustrating an example configuration of the drive system of the shovel of FIG. 1;

FIG. 3 is a schematic diagram illustrating an example configuration of a hydraulic system installed in the shovel of FIG. 1;

FIG. 4A is a diagram extracting part of the hydraulic system installed in the shovel of FIG. 1;

FIG. 4B is a diagram extracting part of the hydraulic system installed in the shovel of FIG. 1;

FIG. 4C is a diagram extracting part of the hydraulic system installed in the shovel of FIG. 1;

FIG. 5 is a flowchart of a mode switching process;

FIG. 6 is a flowchart of a slinging assist process;

FIG. 7A is an example of an image displayed on a display device during the execution of the slinging assist process;

FIG. 7B is an example of an image displayed on the display device during the execution of the slinging assist process;

FIG. 7C is an example of an image displayed on the display device during the execution of the slinging assist process;

FIG. 8 is an example of an output image displayed on the display device;

FIG. 9A is a diagram illustrating the state of a suspension load suspended from a hook as viewed from the cabin side;

FIG. 9B is a diagram illustrating the state of the suspension load suspended from the hook as viewed from the cabin side;

FIG. 10A is a diagram illustrating the state of the suspension load suspended from the hook as viewed from the cabin side;

FIG. 10B is a diagram illustrating the state of the suspension load suspended from the hook as viewed from the cabin side;

FIG. 11A is a diagram illustrating an example configuration of the hook;

FIG. 11B is a diagram illustrating the example configuration of the hook;

FIG. 12 is a plan view of the shovel including a space recognition device;

FIG. 13 is another example of the output image displayed on the display device;

FIG. 14 is yet another example of the output image displayed on the display device;

FIG. 15 is a schematic diagram illustrating an example configuration of a shovel management system;

FIG. 16 is an example of an output image displayed on a display device of a management apparatus; and

FIG. 17 is another example of an output image displayed on the display device of the management apparatus.

### DETAILED DESCRIPTION

The related-art shovel, however, may erroneously determine that the hook is stored in the storage part although the hook is actually pulled out from the storage part, because of the breakage or the like of an electrical cable connected to the proximity switch. In this case, crane work may be performed with the attachment remaining unrestricted in movement.

Therefore, it is desired to provide a shovel that can more reliably switch the operating mode to a crane mode when performing crane work.

According to an aspect of the present invention, a shovel that can more reliably switch the operating mode to a crane mode when performing crane work is provided.

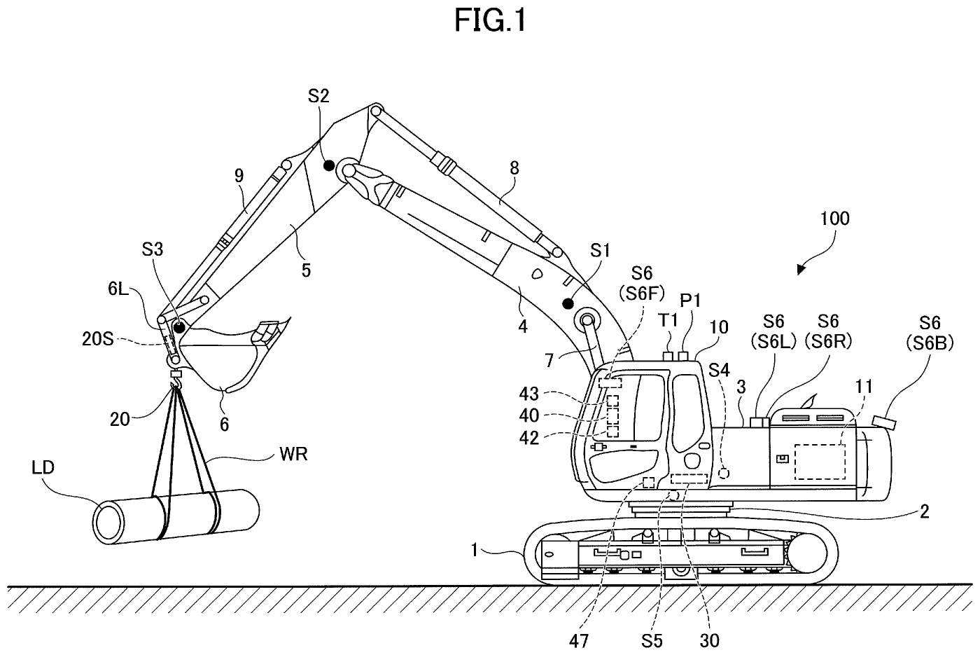

FIG. 1 is a side view of a shovel 100 serving as an excavator according to an embodiment of the present invention. An upper turning body 3 is turnably mounted on a lower traveling body 1 of the shovel 100 via a turning mechanism 2. A boom 4 is attached to the upper turning body 3. An arm 5 is attached to the distal end of the boom 4, and a bucket 6 serving as an end attachment is attached to the distal end of the arm 5.

The boom 4, the arm 5, and the bucket 6 form an excavation attachment that is an example of an attachment. The boom 4 is driven by a boom cylinder 7, the arm 5 is driven by an arm cylinder 8, and the bucket 6 is driven by a bucket cylinder 9. A boom angle sensor S1 is attached to the boom 4, an arm angle sensor S2 is attached to the arm 5, and a bucket angle sensor S3 is attached to the bucket 6.

The boom angle sensor S1, which is an example of a posture detector, is configured to detect the rotation angle of the boom 4. According to this embodiment, the boom angle sensor S1 is an acceleration sensor and can detect the rotation angle of the boom 4 relative to the upper turning body 3 (hereinafter, “boom angle”). For example, the boom angle is smallest when the boom 4 is lowest and increases as the boom 4 is raised.

The arm angle sensor S2, which is an example of a posture detector, is configured to detect the rotation angle of the arm 5. According to this embodiment, the arm angle sensor S2 is an acceleration sensor and can detect the rotation angle of the arm 5 relative to the boom 4 (hereinafter, “arm angle”). For example, the arm angle is smallest when the arm 5 is most closed and increases as the arm 5 is opened.

The bucket angle sensor S3, which is an example of a posture detector, is configured to detect the rotation angle of the bucket 6. According to this embodiment, the bucket angle sensor S3 is an acceleration sensor and can detect the rotation angle of the bucket 6 relative to the arm 5 (hereinafter, “bucket angle”). For example, the bucket angle is smallest when the bucket 6 is most closed and increases as the bucket 6 is opened.

Each of the boom angle sensor S1, the arm angle sensor S2, and the bucket angle sensor S3 may alternatively be a potentiometer using a variable resistor, a stroke sensor that detects the stroke amount of a corresponding hydraulic cylinder, a rotary encoder that detects a rotation angle about a link pin, a gyroscope, a combination of an acceleration sensor and a gyroscope, or the like.

According to this embodiment, the bucket 6 is connected to an end of the bucket cylinder 9 via a bucket link 6L. The bucket link 6L includes a storage part 20S for storing a hook 20 used in crane work. The hook 20 is stored in the storage part 20S when excavation work is performed and is pulled out from the storage part 20S as illustrated in FIG. 1 when crane work is performed.

A cabin 10 that is a cab is provided and a power source such as an engine 11 is mounted on the upper turning body 3. Furthermore, a controller 30, a display device 40, an input device 42, an audio output device 43, a storage device 47, a positioning device P1, a body tilt sensor S4, a turning angular velocity sensor S5, an object monitoring device S6, and a communications device T1 are attached to the upper turning body 3.

The controller 30 operates as a main control part to control the driving of the shovel 100. According to this embodiment, the controller 30 is constituted of a computer including a CPU, a RAM, a ROM, etc. Various functions of the controller 30 are implemented by the CPU executing programs stored in the ROM, for example. The various functions include, for example, a machine guidance function to guide (give directions to) an operator in manually operating the shovel 100 directly or manually operating the shovel 100 remotely, a machine control function to automatically or semi-automatically assist the operator in manually operating the shovel 100 directly or manually operating the shovel 100 remotely, and an automatic control function to implement unmanned operation of the shovel 100 (with no operator). The automatic assist through the machine control function includes, for example, causing an unoperated actuator to operate, and the semi-automatic assist through the machine control function includes, for example, increasing or decreasing the movement of an operated actuator. A machine guidance device 50 included in the controller 30 is configured to be able to execute the machine guidance function, the machine control function, and the automatic control function.

The display device 40 is configured to display various kinds of information. The display device 40 may be connected to the controller 30 via a communications network such as a CAN or may be connected to the controller 30 via a dedicated line.

The input device 42 is so configured as to enable the operator to input various kinds of information to the controller 30. The input device 42 includes a touchscreen, a knob switch, a membrane switch, etc., provided in the cabin 10.

The audio output device 43 is configured to output sound or voice. The audio output device 43 may be, for example, an in-vehicle loudspeaker connected to the controller 30 or an alarm such as a buzzer. According to this embodiment, the audio output device 43 outputs various kinds of information in the form of sound or voice in response to an audio output command from the controller 30.

The storage device 47 is configured to store various kinds of information. Examples of the storage device 47 include a nonvolatile storage medium such as a semiconductor memory. The storage device 47 may store the output information of various devices while the shovel 100 is in operation and may store information obtained through various devices before the shovel 100 starts to operate. The storage device 47 may store, for example, data on an intended work surface obtained through the communications device T1, etc. The intended work surface may be set by the operator of the shovel 100 or may be set by a work manager or the like.

The positioning device P1 is configured to measure the position of the upper turning body 3. The positioning device P1 may also be configured to measure the orientation of the upper turning body 3. The positioning device P1 is, for example, a GNSS compass, and detects the position and orientation of the upper turning body 3 to output detection values to the controller 30. Therefore, the positioning device P1 can operate as an orientation detector to detect the orientation of the upper turning body 3. The orientation detector may be an azimuth sensor attached to the upper turning body 3.

The body tilt sensor S4 is configured to detect the inclination of the upper turning body 3. According to this embodiment, the body tilt sensor S4 is an acceleration sensor that detects the upper turning body 3's tilt angle about its longitudinal axis and tilt angle about its lateral axis to a virtual horizontal plane. For example, the longitudinal axis and the lateral axis of the upper turning body 3 cross each other at right angles at the shovel center point that is a point on the turning axis of the shovel 100.

The turning angular velocity sensor S5 is configured to detect the turning angular velocity of the upper turning body 3. The turning angular velocity sensor S5 may be configured to detect or calculate the turning angle of the upper turning body 3. According to this embodiment, the turning angular velocity sensor S5 is a gyroscope. The turning angular velocity sensor S5 may also be a resolver, a rotary encoder, or the like.

The object monitoring device S6 is configured to obtain information on the surroundings of the shovel 100. According to this embodiment, the object monitoring device S6 includes a front camera S6F that captures an image of a space in front of the shovel 100, a left camera S6L that captures an image of a space to the left of the shovel 100, a right camera S6R that captures an image of a space to the right of the shovel 100, and a back camera S6B that captures an image of a space behind the shovel 100.

The object monitoring device S6 is, for example, an image capturing device such as a monocular camera including an imaging device such as a CCD or a CMOS, and outputs captured images to the display device 40. The image capturing device may also be a stereo camera, a distance image camera, or the like. The object monitoring device S6 may also be a combination of two different types of image capturing devices. For example, a stereo camera, a distance image camera, or the like may be attached to the shovel 100 separately from a monocular camera. The object monitoring device S6 may also be a millimeter wave radar, a laser range sensor, a LIDAR or the like, and may also be a combination of an image capturing device and a millimeter wave radar, a combination of a laser range sensor and a LIDAR, or the like.

The front camera S6F is attached to, for example, the ceiling of the cabin 10, namely, the inside of the cabin 10. The front camera S6F may alternatively be attached to the roof of the cabin 10, namely, the outside of the cabin 10. The left camera S6L is attached to the left end of the upper surface of the upper turning body 3. The right camera S6R is attached to the right end of the upper surface of the upper turning body 3. The back camera S6B is attached to the back end of the upper surface of the upper turning body 3.

The communications device T1 is configured to control communications with external apparatuses outside the shovel 100. According to this embodiment, the communications device T1 controls communications with external apparatuses via at least one of a satellite communications network, a cellular phone network, the Internet, etc.

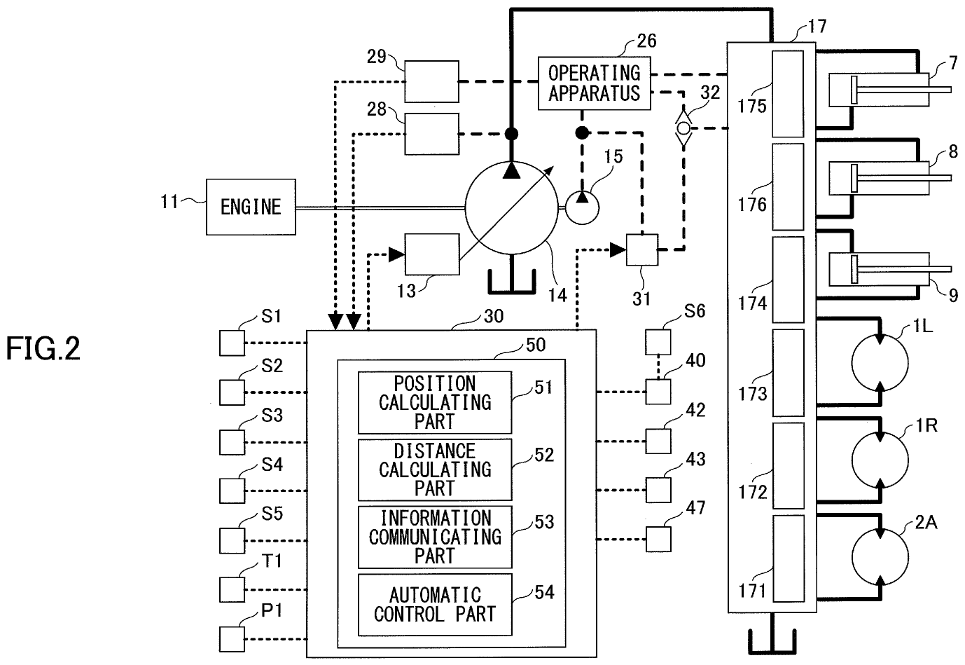

FIG. 2 is a block diagram illustrating an example configuration of the drive system of the shovel 100, in which a mechanical power transmission system, a hydraulic oil line, a pilot line, and an electric control system are indicated by a double line, a solid line, a dashed line, and a dotted line, respectively.

The drive system of the shovel 100 mainly includes the engine 11, a regulator 13, a main pump 14, a pilot pump 15, a control valve 17, an operating apparatus 26, a discharge pressure sensor 28, an operating pressure sensor 29, the controller 30, and a proportional valve 31.

The engine 11 is a drive source of the shovel. According to this embodiment, the engine 11 is a diesel engine that so operates as to maintain a predetermined rotational speed. The output shaft of the engine 11 is coupled to the respective input shafts of the main pump 14 and the pilot pump 15.

The main pump 14 is configured to supply hydraulic oil to the control valve 17 via a hydraulic oil line. According to this embodiment, the main pump 14 is a swash plate variable displacement hydraulic pump.

The regulator 13 is configured to control the discharge quantity of the main pump 14. According to this embodiment, the regulator 13 controls the discharge quantity of the main pump 14 by adjusting the swash plate tilt angle of the main pump 14 in response to a control command from the controller 30. For example, the controller 30 varies the discharge quantity of the main pump 14 by outputting a control command to the regulator 13 in accordance with the output of the operating pressure sensor 29 or the like.

The pilot pump 15 is configured to supply hydraulic oil to various hydraulic control apparatuses including the operating apparatus 26 and the proportional valve 31 via a pilot line. According to this embodiment, the pilot pump 15 is a fixed displacement hydraulic pump. The pilot pump 15, however, may be omitted. In this case, the function carried by the pilot pump 15 may be implemented by the main pump 14. That is, the main pump 14 may have the function of supplying hydraulic oil to the operating apparatus 26, the proportional valve 31, etc., after reducing the pressure of the hydraulic oil with a throttle or the like, apart from the function of supplying hydraulic oil to the control valve 17.

The control valve 17 is a hydraulic control device that controls a hydraulic system in the shovel 100. According to this embodiment, the control valve 17 includes control valves 171 through 176. The control valve 17 can selectively supply hydraulic oil discharged by the main pump 14 to one or more hydraulic actuators through the control valves 171 through 176. The control valves 171 through 176 control the flow rate of hydraulic oil flowing from the main pump 14 to hydraulic actuators and the flow rate of hydraulic oil flowing from hydraulic actuators to a hydraulic oil tank. The hydraulic actuators include the boom cylinder 7, the arm cylinder 8, the bucket cylinder 9, a left traveling hydraulic motor 1L, a right traveling hydraulic motor 1R, and a turning hydraulic motor 2A. The turning hydraulic motor 2A may alternatively be a turning electric motor serving as an electric actuator.

The operating apparatus 26 is an apparatus that the operator uses to operate actuators. The actuators include at least one of a hydraulic actuator and an electric actuator. According to this embodiment, the operating apparatus 26 supplies hydraulic oil discharged by the pilot pump 15 to a pilot port of a corresponding control valve in the control valve 17 via a pilot line. The pressure of hydraulic oil supplied to each pilot port (pilot pressure) is, in principle, a pressure commensurate with the direction of operation and the amount of operation of the operating apparatus 26 for a corresponding hydraulic actuator. At least one of the operating apparatus 26 is configured to be able to supply hydraulic oil discharged by the pilot pump 15 to a pilot port of a corresponding control valve in the control valve 17 via a pilot line and a shuttle valve 32.

The discharge pressure sensor 28 is configured to detect the discharge pressure of the main pump 14. According to this embodiment, the discharge pressure sensor 28 outputs the detected value to the controller 30.

The operating pressure sensor 29 is configured to detect the details of the operator's operation using the operating apparatus 26. According to this embodiment, the operating pressure sensor 29 detects the direction of operation and the amount of operation of the operating apparatus 26 corresponding to each actuator in the form of pressure and outputs the detected value to the controller 30. The operation details of the operating apparatus 26 may be detected using a sensor other than an operating pressure sensor.

The proportional valve 31 is placed in a conduit connecting the pilot pump 15 and the shuttle valve 32, and is configured to be able to change the flow area of the conduit. According to this embodiment, the proportional valve 31 operates in response to a control command output by the controller 30. Therefore, the controller 30 can supply hydraulic oil discharged by the pilot pump 15 to a pilot port of a corresponding control valve in the control valve 17 via the proportional valve 31 and the shuttle valve 32, independent of the operator's operation of the operating apparatus 26.

The shuttle valve 32 includes two inlet ports and one outlet port. Of the two inlet ports, one is connected to the operating apparatus 26 and the other is connected to the proportional valve 31. The outlet port is connected to a pilot port of a corresponding control valve in the control valve 17. Therefore, the shuttle valve 32 can cause the higher one of a pilot pressure generated by the operating apparatus 26 and a pilot pressure generated by the proportional valve 31 to act on a pilot port of a corresponding control valve.

According to this configuration, the controller 30 can operate a hydraulic actuator corresponding to a specific operating apparatus 26 even when no operation is performed on the specific operating apparatus 26.

Next, the machine guidance device 50 included in the controller 30 is described. The machine guidance device 50 is configured to execute the machine guidance function, for example. According to this embodiment, the machine guidance device 50, for example, notifies the operator of work information that is at least one of the distance between the intended work surface and the working part of the attachment, the distance between the position of the center of gravity of a suspension load (LD) (see FIG. 1) and a position of suspension on the hook 20, etc. Data on the intended work surface are, for example, data on a work surface at the time of completion of work, and are prestored in the storage device 47. The data on the intended work surface are expressed in, for example, a reference coordinate system. The reference coordinate system is, for example, the world geodetic system. The world geodetic system is a three-dimensional Cartesian coordinate system with the origin at the center of mass of the Earth, the X-axis oriented toward the point of intersection of the prime meridian and the equator, the Y-axis oriented toward 90 degrees east longitude, and the Z-axis oriented toward the Arctic pole. The operator may set any point at a construction site as a reference point and set the intended work surface based on the relative positional relationship between each point of the intended work surface and the reference point. The working part of the attachment is, for example, the teeth tips of the bucket 6, the back surface of the bucket 6, or the like. The suspension load LD is, for example, an object that hinders excavation work, an object to be buried, a buried object or the like, and is specifically a pipe, lumber, a bag of waste soil, a tetrapod or the like. The machine guidance device 50 provides guidance on operating the shovel 100 by notifying the operator of the work information via at least one of the display device 40, the audio output device 43, etc.

The machine guidance device 50 may execute the machine control function to automatically assist the operator in manually operating the shovel 100 directly or manually operating the shovel 100 remotely. For example, when the operator is manually performing operation for excavation, the machine guidance device 50 may cause at least one of the boom 4, the arm 5, and the bucket 6 to automatically operate such that the leading edge position of the bucket 6 coincides with the intended work surface. The machine guidance device 50 may also execute the automatic control function to implement unmanned operation of the shovel 100.

While incorporated into the controller 30 according to this embodiment, the machine guidance device 50 may be a control device provided separately from the controller 30. In this case, for example, like the controller 30, the machine guidance device 50 is constituted of a computer including a CPU and an internal memory. The CPU executes programs stored in the internal memory to implement various functions of the machine guidance device 50. The machine guidance device 50 and the controller 30 are connected by a communications network such as a CAN to be able to communicate with each other.

Specifically, the machine guidance device 50 obtains information from the boom angle sensor S1, the arm angle sensor S2, the bucket angle sensor S3, the body tilt sensor S4, the turning angular velocity sensor S5, the object monitoring device S6, the positioning device P1, the communications device T1, the input device 42, etc. Then, the machine guidance device 50, for example, calculates the vertical distance between the bucket 6 and the intended work surface based on the obtained information, and notifies the operator of the shovel 100 of the size of the vertical distance between the bucket 6 and the intended work surface through audio and image display. Furthermore, the machine guidance device 50 may, for example, calculate the horizontal distance between the position of suspension on the hook 20 and the position of the center of gravity of the suspension load LD and notify the operator of the shovel 100 of the size of the horizontal distance between the position of suspension and the position of the center of gravity through audio and image display. The position of suspension is, for example, a position where a wire WR (see FIG. 1) is hung. Furthermore, the machine guidance device 50 may, for example, notify the operator of the shovel 100 of the size of the vertical distance between the position of suspension on the hook 20 and a target position of suspension. The target position of suspension is a position set directly above the position of the center of gravity of the suspension load LD, whose height is determined based on the length of the wire WR. In this case, the length of the wire WR may be input in advance via the input device 42.

To implement the above-described functions, the machine guidance device 50 includes a position calculating part 51, a distance calculating part 52, an information communicating part 53, and an automatic control part 54.

The position calculating part 51 is configured to calculate the position of an object whose location is to be determined. According to this embodiment, the position calculating part 51 calculates the coordinate point of the working part of the attachment in the reference coordinate system. Specifically, the position calculating part 51 calculates the coordinate point of the teeth tips of the bucket 6 from the respective rotation angles of the boom 4, the arm 5, and the bucket 6. The same is true for the coordinate point of the position of suspension on the hook 20.

The distance calculating part 52 is configured to calculate the distance between two objects whose locations are to be determined. According to this embodiment, the distance calculating part 52 calculates the vertical distance between the teeth tips of the bucket 6 and the intended work surface. The same is true for the horizontal distance between the position of suspension on the hook 20 and the position of the center of gravity of the suspension load LD. The coordinate point of the center of gravity of the suspension load LD is determined, for example, based on the outline of the suspension load LD derived from an image captured by an image capturing device serving as the object monitoring device S6. In this case, the image capturing device serving as the object monitoring device S6 operates as a suspension load condition detecting part. The coordinate point of the center of gravity of the suspension load LD may also be determined, for example, based on the outline of the suspension load LD derived from information obtained by a LIDAR serving as the object monitoring device S6, or the like. In this case, the LIDAR serving as the object monitoring device S6 operates as a suspension load condition detecting part. The coordinate point of the center of gravity of the suspension load LD may also be input through the input device 42.

The information communicating part 53 is configured to communicate various kinds of information to the operator of the shovel 100. According to this embodiment, the information communicating part 53 notifies the operator of the shovel 100 of the size of each of the various distances calculated by the distance calculating part 52. Specifically, the information communicating part 53 notifies the operator of the shovel 100 of the size of the vertical distance between the teeth tips of the bucket 6 and the intended work surface, using visual information and aural information. The information communicating part 53 may also use tactile information. For example, the information communicating part 53 may notify the operator of the size of the vertical distance between the teeth tips of the bucket 6 and the intended work surface, using intermittent sounds through the audio output device 43. In this case, the information communicating part 53 may reduce the interval between intermittent sounds as the vertical distance decreases. The information communicating part 53 may use a continuous sound and may represent variations in the size of the vertical distance by changing at least one of the pitch, loudness, etc., of the sound. The same is true for the horizontal distance between the position of suspension on the hook 20 and the position of the center of gravity of the suspension load LD.

When the teeth tips of the bucket 6 are positioned lower than the intended work surface, the information communicating part 53 may issue an alarm. The alarm is, for example, a continuous sound significantly louder than the intermittent sounds. The same is true for the case where the position of suspension on the hook 20 is at a position lower than the suspension load LD and the case where hoisting is performed with the horizontal distance between the position of suspension on the hook 20 and the position of the center of gravity of the suspension load LD exceeding a predetermined distance.

The information communicating part 53 may display the size of the vertical distance between the teeth tips of the bucket 6 and the intended work surface on the display device 40 as work information. For example, the display device 40 displays the work information received from the information communicating part 53 on a screen, together with image data received from an image capturing device serving as the object monitoring device S6. The information communicating part 53 may notify the operator of the size of the vertical distance, using, for example, an image of an analog meter, an image of a bar graph indicator, or the like. The same is true for the horizontal distance between the position of suspension on the hook 20 and the position of the center of gravity of the suspension load LD.

The automatic control part 54 is configured to assist the operator in manually operating the shovel 100 directly or manually operating the shovel 100 remotely by automatically moving actuators. For example, the automatic control part 54 may automatically extend or retract at least one of the boom cylinder 7, the arm cylinder 8, and the bucket cylinder 9 such that the position of the teeth tips of the bucket 6 coincides with the intended work surface, while the operator is manually performing an arm closing operation. In this case, for example, only by operating an arm operating lever in a closing direction, the operator can close the arm 5 while making the teeth tips of the bucket 6 coincide with the intended work surface. This automatic control may be executed in response to the depression of a predetermined switch that is an input device included in the input device 42. The predetermined switch is, for example, a machine control switch (hereinafter, “MC switch”), and may be placed at the end of the arm operating lever as a knob switch.

According to this embodiment, the automatic control part 54 can automatically move each actuator by individually and automatically controlling a pilot pressure that acts on a control valve corresponding to each actuator.

The automatic control part 54 may automatically move at least one of the actuators to move the position of suspension on the hook 20 to directly above the position of the center of gravity of the suspension load LD when a crane mode is selected as the operating mode. For example, the automatic control part 54 may turn the upper turning body 3 by automatically rotating the turning hydraulic motor 2A and may extend or retract the attachment by automatically extending or retracting the boom cylinder 7 and the arm cylinder 8.

The operating mode includes, for example, a crane mode and a shovel mode. The operator of the shovel 100 can switch the operating mode by operating a predetermined switch placed in the cabin 10. The predetermined switch is, for example, a mode switch serving as a push button switch placed near the display device 40. The predetermined switch may also be a mode switch serving as a software button displayed on the display device 40 including a touchscreen.

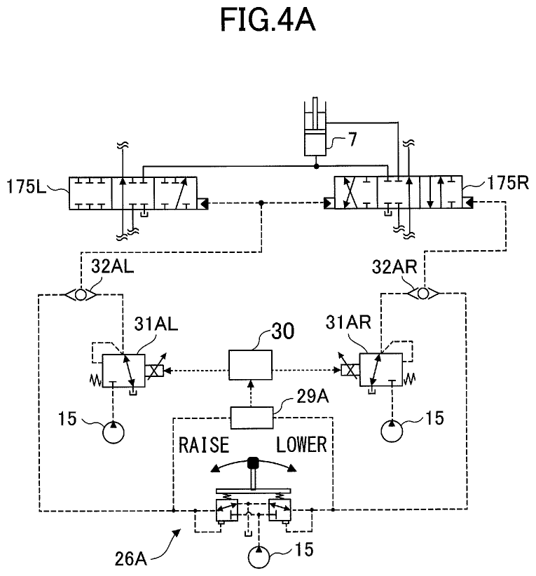

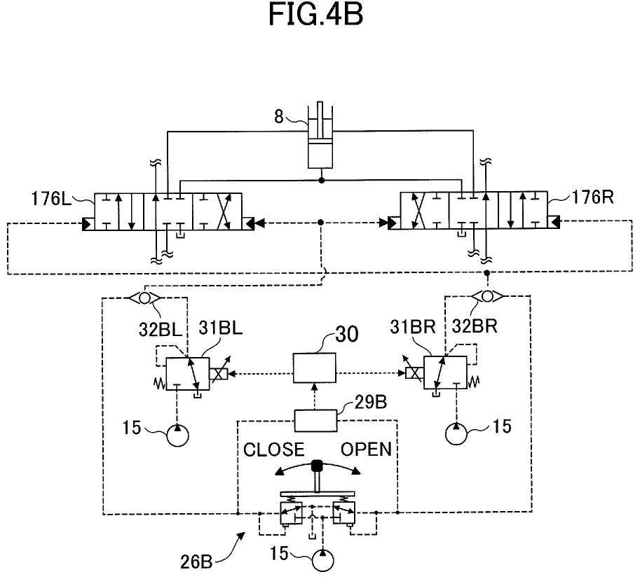

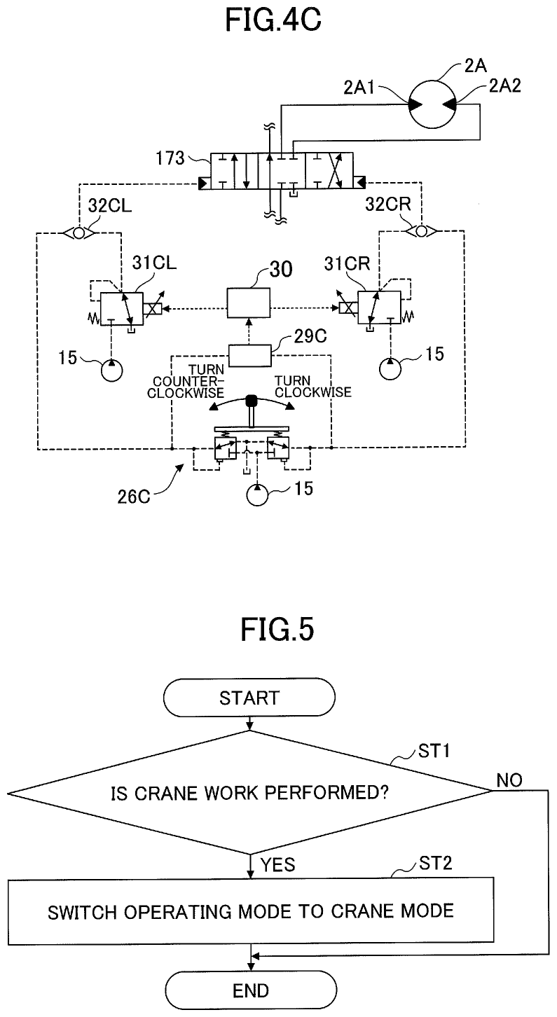

The actuators are more restricted in operating speed in the crane mode than in the shovel mode. For example, the turning speed of the upper turning body 3 when a turning operating lever 26C (see FIG. 4C) is operated in the crane mode is so restricted as to be lower than the turning speed of the upper turning body 3 when the turning operating lever 26C is operated for the same amount of operation in the shovel mode. The same is true for the operating speeds of the left traveling hydraulic motor 1L, the right traveling hydraulic motor 1R, the boom 4, the arm 5, and the bucket 6. The speed restriction is achieved by, for example, at least one of reducing the spool stroke amount of a control valve relative to the amount of operation of the operating apparatus 26, reducing the discharge quantity of the main pump 14, reducing the engine rotational speed, etc. According to this embodiment, however, power is not restricted in the crane mode. That is, a maximum load that can be hoisted is not restricted.

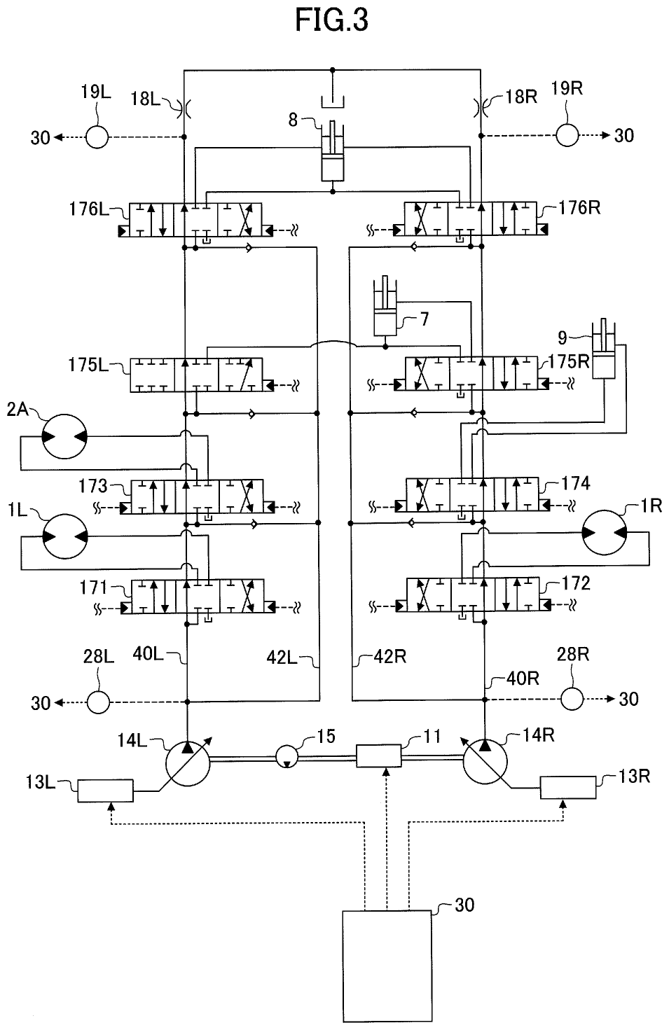

Next, an example configuration of a hydraulic system installed in the shovel 100 is described with reference to FIG. 3. FIG. 3 is a schematic diagram illustrating an example configuration of the hydraulic system installed in the shovel 100 of FIG. 1. In FIG. 3, a mechanical power system, a hydraulic oil line, a pilot line, and an electric control system are indicated by a double line, a solid line, a dashed line, and a dotted line, respectively, the same as in FIG. 2.

The hydraulic system circulates hydraulic oil from a main pump 14L driven by the engine 11 to the hydraulic oil tank via a center bypass conduit 40L and a parallel conduit 42L. The hydraulic system circulates hydraulic oil from a main pump 14R driven by the engine 11 to the hydraulic oil tank via a center bypass conduit 40R and a parallel conduit 42R. The main pump 14L and the main pump 14R correspond to the main pump 14 of FIG. 2.

The center bypass conduit 40L is a hydraulic oil line that passes through the control valves 171 and 173 and control valves 175L and 176L placed in the control valve 17. The center bypass conduit 40R is a hydraulic oil line that passes through the control valves 172 and 174 and control valves 175R and 176R placed in the control valve 17. The control valve 175L and the control valve 175R correspond to the control valve 175 of FIG. 2. The control valve 176L and the control valve 176R correspond to the control valve 176 of FIG. 2.

The control valve 171 is a spool valve that switches the flow of hydraulic oil in order to supply hydraulic oil discharged by the main pump 14L to the left traveling hydraulic motor 1L and to discharge hydraulic oil discharged by the left traveling hydraulic motor 1L to the hydraulic oil tank.

The control valve 172 is a spool valve that switches the flow of hydraulic oil in order to supply hydraulic oil discharged by the main pump 14R to the right traveling hydraulic motor 1R and to discharge hydraulic oil discharged by the right traveling hydraulic motor 1R to the hydraulic oil tank.

The control valve 173 is a spool valve that switches the flow of hydraulic oil in order to supply hydraulic oil discharged by the main pump 14L to the turning hydraulic motor 2A and to discharge hydraulic oil discharged by the turning hydraulic motor 2A to the hydraulic oil tank.

The control valve 174 is a spool valve for supplying hydraulic oil discharged by the main pump 14R to the bucket cylinder 9 and discharging hydraulic oil in the bucket cylinder 9 to the hydraulic oil tank.

The control valve 175L is a spool valve that switches the flow of hydraulic oil in order to supply hydraulic oil discharged by the main pump 14L to the boom cylinder 7. The control valve 175R is a spool valve that switches the flow of hydraulic oil in order to supply hydraulic oil discharged by the main pump 14R to the boom cylinder 7 and to discharge hydraulic oil in the boom cylinder 7 to the hydraulic oil tank.

The control valve 176L is a spool valve that switches the flow of hydraulic oil in order to supply hydraulic oil discharged by the main pump 14L to the arm cylinder 8 and to discharge hydraulic oil in the arm cylinder 8 to the hydraulic oil tank. The control valve 176R is a spool valve that switches the flow of hydraulic oil in order to supply hydraulic oil discharged by the main pump 14R to the arm cylinder 8 and to discharge hydraulic oil in the arm cylinder 8 to the hydraulic oil tank.

The parallel conduit 42L is a hydraulic oil line parallel to the center bypass conduit 40L. When the flow of hydraulic oil through the center bypass conduit 40L is restricted or blocked by at least one of the control valves 171, 173 and 175L, the parallel conduit 42L can supply hydraulic oil to a control valve further downstream. The parallel conduit 42R is a hydraulic oil line parallel to the center bypass conduit 40R. When the flow of hydraulic oil through the center bypass conduit 40R is restricted or blocked by at least one of the control valves 172, 174 and 175R, the parallel conduit 42R can supply hydraulic oil to a control valve further downstream.

A regulator 13L controls the discharge quantity of the main pump 14L by adjusting the swash plate tilt angle of the main pump 14L in accordance with the discharge pressure of the main pump 14L or the like. A regulator 13R controls the discharge quantity of the main pump 14R by adjusting the swash plate tilt angle of the main pump 14R in accordance with the discharge pressure of the main pump 14R or the like. The regulator 13L and the regulator 13R correspond to the regulator 13 of FIG. 2. The regulator 13L, for example, reduces the discharge quantity of the main pump 14L by adjusting its swash plate tilt angle, according as the discharge pressure of the main pump 14L increases. The same is the case with the regulator 13R. This is for preventing the absorbed power (absorbed horsepower) of the main pump 14 expressed by the product of the discharge pressure and the discharge quantity from exceeding the output power (output horsepower) of the engine 11.

A discharge pressure sensor 28L, which is an example of the discharge pressure sensor 28, detects the discharge pressure of the main pump 14L, and outputs the detected value to the controller 30. The same is the case with a discharge pressure sensor 28R.

Here, negative control adopted in the hydraulic system of FIG. 3 is described.

A throttle 18L is placed between the most downstream control valve 176L and the hydraulic oil tank in the center bypass conduit 40L. The flow of hydraulic oil discharged by the main pump 14L is restricted by the throttle 18L. The throttle 18L generates a control pressure for controlling the regulator 13L. A control pressure sensor 19L is a sensor for detecting the control pressure, and outputs the detected value to the controller 30.

A throttle 18R is placed between the most downstream control valve 176R and the hydraulic oil tank in the center bypass conduit 40R. The flow of hydraulic oil discharged by the main pump 14R is restricted by the throttle 18R. The throttle 18R generates a control pressure for controlling the regulator 13R. A control pressure sensor 19R is a sensor for detecting the control pressure, and outputs the detected value to the controller 30.

The controller 30 controls the discharge quantity of the main pump 14L by adjusting the swash plate tilt angle of the main pump 14L in accordance with the control pressure detected by the control pressure sensor 19L or the like. The controller 30, for example, decreases the discharge quantity of the main pump 14L as the control pressure increases, and increases the discharge quantity of the main pump 14L as the control pressure decreases. Likewise, the controller 30 controls the discharge quantity of the main pump 14R by adjusting the swash plate tilt angle of the main pump 14R in accordance with the control pressure detected by the control pressure sensor 19R or the like. The controller 30 decreases the discharge quantity of the main pump 14R as the control pressure increases, and increases the discharge quantity of the main pump 14R as the control pressure decreases.

Specifically, as illustrated in FIG. 3, in a standby state where none of the hydraulic actuators is operated in the shovel 100, hydraulic oil discharged by the main pump 14L arrives at the throttle 18L through the center bypass conduit 40L. The flow of hydraulic oil discharged by the main pump 14L increases the control pressure generated upstream of the throttle 18L. As a result, the controller 30 decreases the discharge quantity of the main pump 14L to a minimum allowable discharge quantity to reduce pressure loss (pumping loss) during the passage of the discharged hydraulic oil through the center bypass conduit 40L. Likewise, in the standby state, hydraulic oil discharged by the main pump 14R arrives at the throttle 18R through the center bypass conduit 40R. The flow of hydraulic oil discharged by the main pump 14R increases the control pressure generated upstream of the throttle 18R. As a result, the controller 30 decreases the discharge quantity of the main pump 14R to a minimum allowable discharge quantity to reduce pressure loss (pumping loss) during the passage of the discharged hydraulic oil through the center bypass conduit 40R.

In contrast, when a hydraulic actuator is operated, hydraulic oil discharged by the main pump 14L flows into the operated hydraulic actuator via a control valve corresponding to the operated hydraulic actuator. The flow of hydraulic oil discharged by the main pump 14L that arrives at the throttle 18L is reduced in amount or lost, so that the control pressure generated upstream of the throttle 18L is reduced. As a result, the controller 30 increases the discharge quantity of the main pump 14L to circulate sufficient hydraulic oil to the operated hydraulic actuator to ensure driving of the operated hydraulic actuator. Likewise, when a hydraulic actuator is operated, hydraulic oil discharged by the main pump 14R flows into the operated hydraulic actuator via a control valve corresponding to the operated hydraulic actuator. The flow of hydraulic oil discharged by the main pump 14R that arrives at the throttle 18R is reduced in amount or lost, so that the control pressure generated upstream of the throttle 18R is reduced. As a result, the controller 30 increases the discharge quantity of the main pump 14R to circulate sufficient hydraulic oil to the operated hydraulic actuator to ensure driving of the operated hydraulic actuator.

According to the configuration as described above, the hydraulic system of FIG. 3 can reduce unnecessary energy consumption in the main pump 14L and the main pump 14R in the standby state. The unnecessary energy consumption includes pumping loss that hydraulic oil discharged by the main pump 14L causes in the center bypass conduit 40L and pumping loss that hydraulic oil discharged by the main pump 14R causes in the center bypass conduit 40R. Furthermore, in the case of actuating hydraulic actuators, the hydraulic system of FIG. 3 can supply necessary and sufficient hydraulic oil from the main pump 14L and the main pump 14R to hydraulic actuators to be actuated.

Next, a configuration for causing an actuator to automatically operate is described with reference to FIGS. 4A through 4C. FIGS. 4A through 4C are diagrams extracting part of the hydraulic system. Specifically, FIG. 4A is a diagram extracting part of the hydraulic system related to the operation of the boom cylinder 7. FIG. 4B is a diagram extracting part of the hydraulic system related to the operation of the arm cylinder 8. FIG. 4C is a diagram extracting part of the hydraulic system related to the operation of the turning hydraulic motor 2A.

A boom operating lever 26A in FIG. 4A is an example of the operating apparatus 26 and is used to operate the boom 4. The boom operating lever 26A uses hydraulic oil discharged by the pilot pump 15 to cause a pilot pressure commensurate with the details of an operation to act on respective pilot ports of the control valve 175L and the control valve 175R. Specifically, when operated in a boom raising direction, the boom operating lever 26A causes a pilot pressure commensurate with the amount of operation to act on the right pilot port of the control valve 175L and the left pilot port of the control valve 175R. When operated in a boom lowering direction, the boom operating lever 26A causes a pilot pressure commensurate with the amount of operation to act on the right pilot port of the control valve 175R.

An operating pressure sensor 29A, which is an example of the operating pressure sensor 29, detects the details of the operator's operation of the boom operating lever 26A in the form of pressure, and outputs the detected value to the controller 30. Examples of the operation details include the direction of operation and the amount of operation (the angle of operation).

A proportional valve 31AL and a proportional valve 31AR are examples of the proportional valve 31. A shuttle valve 32AL and a shuttle valve 32AR are examples of the shuttle valve 32. The proportional valve 31AL operates in response to a current command output by the controller 30. The proportional valve 31AL controls a pilot pressure due to hydraulic oil introduced to the right pilot port of the control valve 175L and the left pilot port of the control valve 175R from the pilot pump 15 via the proportional valve 31AL and the shuttle valve 32AL. The proportional valve 31AR operates in response to a current command output by the controller 30. The proportional valve 31AR controls a pilot pressure due to hydraulic oil introduced to the right pilot port of the control valve 175R from the pilot pump 15 via the proportional valve 31AR and the shuttle valve 32AR. The proportional valve 31AL can control the pilot pressure such that the control valve 175L and the control valve 175R can stop at a desired valve position. The proportional valve 31AR can control the pilot pressure such that the control valve 175R can stop at a desired valve position.

According to this configuration, the controller 30 can supply hydraulic oil discharged by the pilot pump 15 to the right pilot port of the control valve 175L and the left pilot port of the control valve 175R through the proportional valve 31AL and the shuttle valve 32AL, independent of the operator's boom raising operation. That is, the controller 30 can automatically raise the boom 4. Furthermore, the controller 30 can supply hydraulic oil discharged by the pilot pump 15 to the right pilot port of the control valve 175R through the proportional valve 31AR and the shuttle valve 32AR, independent of the operator's boom lowering operation. That is, the controller 30 can automatically lower the boom 4.

An arm operating lever 26B in FIG. 4B is another example of the operating apparatus 26 and is used to operate the arm 5. The arm operating lever 26B uses hydraulic oil discharged by the pilot pump 15 to cause a pilot pressure commensurate with the details of an operation to act on respective pilot ports of the control valve 176L and the control valve 176R. Specifically, when operated in an arm closing direction, the arm operating lever 26B causes a pilot pressure commensurate with the amount of operation to act on the right pilot port of the control valve 176L and the left pilot port of the control valve 176R. When operated in an arm opening direction, the arm operating lever 26B causes a pilot pressure commensurate with the amount of operation to act on the left pilot port of the control valve 176L and the right pilot port of the control valve 176R.

An operating pressure sensor 29B, which is another example of the operating pressure sensor 29, detects the details of the operator's operation of the arm operating lever 26B in the form of pressure, and outputs the detected value to the controller 30.

A proportional valve 31BL and a proportional valve 31BR are other examples of the proportional valve 31. A shuttle valve 32BL and a shuttle valve 32BR are other examples of the shuttle valve 32. The proportional valve 31BL operates in response to a current command output by the controller 30. The proportional valve 31BL controls a pilot pressure due to hydraulic oil introduced to the right pilot port of the control valve 176L and the left pilot port of the control valve 176R from the pilot pump 15 via the proportional valve 31BL and the shuttle valve 32BL. The proportional valve 31BR operates in response to a current command output by the controller 30. The proportional valve 31BR controls a pilot pressure due to hydraulic oil introduced to the left pilot port of the control valve 176L and the right pilot port of the control valve 176R from the pilot pump 15 via the proportional valve 31BR and the shuttle valve 32BR. Each of the proportional valve 31BL and the proportional valve 31BR can control the pilot pressure such that the control valve 176L and the control valve 176R can stop at a desired valve position.

According to this configuration, the controller 30 can supply hydraulic oil discharged by the pilot pump 15 to the right pilot port of the control valve 176L and the left pilot port of the control valve 176R through the proportional valve 31BL and the shuttle valve 32BL, independent of the operator's arm closing operation. That is, the controller 30 can automatically close the arm 5. Furthermore, the controller 30 can supply hydraulic oil discharged by the pilot pump 15 to the left pilot port of the control valve 176L and the right pilot port of the control valve 176R through the proportional valve 31BR and the shuttle valve 32BR, independent of the operator's arm opening operation. That is, the controller 30 can automatically open the arm 5.

The turning operating lever 26C in FIG. 4C is yet another example of the operating apparatus 26 and is used to turn the upper turning body 3. The turning operating lever 26C uses hydraulic oil discharged by the pilot pump 15 to cause a pilot pressure commensurate with the details of an operation to act on a pilot port of the control valve 173. Specifically, when operated in a counterclockwise turning direction, the turning operating lever 26C causes a pilot pressure commensurate with the amount of operation to act on the left pilot port of the control valve 173. When operated in a clockwise turning direction, the turning operating lever 26C causes a pilot pressure commensurate with the amount of operation to act on the right pilot port of the control valve 173.

An operating pressure sensor 29C, which is yet another example of the operating pressure sensor 29, detects the details of the operator's operation of the turning operating lever 26C in the form of pressure, and outputs the detected value to the controller 30.

A proportional valve 31CL and a proportional valve 31CR are yet other examples of the proportional valve 31. A shuttle valve 32CL and a shuttle valve 32CR are yet other examples of the shuttle valve 32. The proportional valve 31CL operates in response to a current command output by the controller 30. The proportional valve 31CL controls a pilot pressure due to hydraulic oil introduced to the left pilot port of the control valve 173 from the pilot pump 15 via the proportional valve 31CL and the shuttle valve 32CL. The proportional valve 31CR operates in response to a current command output by the controller 30. The proportional valve 31CR controls a pilot pressure due to hydraulic oil introduced to the right pilot port of the control valve 173 from the pilot pump 15 via the proportional valve 31CR and the shuttle valve 32CR. Each of the proportional valve 31CL and the proportional valve 31CR can control the pilot pressure such that the control valve 173 can stop at a desired valve position.

According to this configuration, the controller 30 can supply hydraulic oil discharged by the pilot pump 15 to the left pilot port of the control valve 173 through the proportional valve 31CL and the shuttle valve 32CL, independent of the operator's counterclockwise turning operation. That is, the controller 30 can automatically turn the upper turning body 3 counterclockwise. Furthermore, the controller 30 can supply hydraulic oil discharged by the pilot pump 15 to the right pilot port of the control valve 173 through the proportional valve 31CR and the shuttle valve 32CR, independent of the operator's clockwise turning operation. That is, the controller 30 can automatically turn the upper turning body 3 clockwise.

The shovel 100 may also be configured to automatically open or close the bucket 6 and be configured to automatically move the lower traveling body 1 forward and backward. In this case, part of the hydraulic system related to the operation of the bucket cylinder 9, part of the hydraulic system related to the operation of the left traveling hydraulic motor 1L, and part of the hydraulic system related to the operation of the right traveling hydraulic motor 1R may be configured the same as part of the hydraulic system related to the operation of the boom cylinder 7, etc.

Next, a process of the controller 30 switching the operating mode of the shovel 100 to the crane mode (hereinafter, “mode switching process”) is described with reference to FIG. 5. FIG. 5 is a flowchart of the mode switching process. The controller 30 repeatedly executes this mode switching process at predetermined control intervals.

First, the controller 30 determines whether crane work is performed (step ST1). According to this embodiment, the controller 30 determines whether crane work is about to be performed or whether crane work has been performed, based on an image captured by an image capturing device serving as the object monitoring device S6. Specifically, by executing an image recognition process on an image captured by the front camera S6F, the controller 30 determines whether an image related to crane work is within the captured image. The image related to crane work is, for example, at least one of an image of the suspension load LD to which the wire WR is attached, an image of the hook 20 pulled out from the storage part 20S in the bucket link 6L, an image of the wire WR hung on the hook 20, etc. In response to determining that there is an image related to crane work within the image captured by the front camera S6F, the controller 30 determines that crane work is performed. Furthermore, in response to determining that there is no image related to crane work within the image captured by the front camera S6F, the controller 30 determines that crane work is not performed.

The controller 30 may also be configured to be able to determine that crane work is performed based on the image captured by the front camera S6F when determining that the attachment is in a predetermined posture based on the output of a posture detector. For example, the controller 30 may be configured to be able to determine that crane work is performed only when the bucket 6 is most closed, namely, the bucket cylinder 9 is most extended. In other words, the controller 30 may be configured to be unable to determine that crane work is performed even when determining that there is an image related to crane work within the image captured by the front camera S6F, if determining that the attachment is not in a predetermined posture.

In response to determining that crane work is not performed (NO at step ST1), the controller 30 ends the mode switching process of this time without switching the operating mode to the crane mode.

In response to determining that crane work is performed (YES at step ST1), the controller 30 switches the operating mode to the crane mode (step ST2). According to this embodiment, the controller 30 switches the operating mode to the crane mode when an operation to hoist the suspension load LD is performed after it is determined that crane work is performed. “When an operation to hoist the suspension load LD” includes, for example, when a boom raising operation is performed after the hook 20 is positioned directly above the suspension load LD. The controller 30, however, may switch the operating mode to the crane mode at the point of time when determining that crane work is performed.

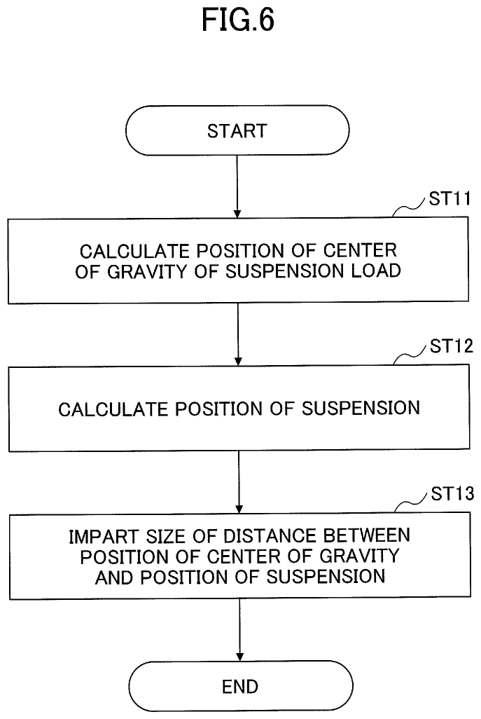

Next, a process of the controller 30 assisting in slinging (hereinafter, “slinging assist process”) is described with reference to FIG. 6. FIG. 6 is a flowchart of the slinging assist process. For example, the controller 30 executes this slinging assist process in response to determining that there is an image of the suspension load LD within an image captured by an image capturing device serving as the object monitoring device S6. The controller 30 may execute this slinging assist process when the controller 30 determines that there is an image of the suspension load LD within an image captured by the front camera S6F and the crane mode is selected by a mode switch.

First, the machine guidance device 50 included in the controller 30 calculates the position of the center of gravity of the suspension load LD (step ST11). According to this embodiment, the machine guidance device 50 derives the outline of the suspension load LD from an image of the suspension load LD included in an image captured by an image capturing device serving as the object monitoring device S6, and derives the coordinate point of the center of gravity of the suspension load LD based on the outline.

Thereafter, the machine guidance device 50 calculates the position of suspension on the hook 20 (step ST12). According to this embodiment, the position calculating part 51 of the machine guidance device 50 calculates the coordinate point of the position of suspension on the hook 20 from the respective rotation angles of the boom 4, the arm 5, and the bucket 6.

Thereafter, the machine guidance device 50 imparts the size of the distance between the position of the center of gravity and the position of suspension (step ST13). According to this embodiment, the distance calculating part 52 of the machine guidance device 50 calculates the horizontal distance between the position of suspension on the hook 20 and the position of the center of gravity of the suspension load LD. The information communicating part 53 of the machine guidance device 50 notifies the operator of the size of the horizontal distance using intermittent sounds through the audio output device 43. Specifically, the information communicating part 53 notifies the operator of the size of the horizontal distance using intermittent sounds that are output at shorter intervals as the horizontal distance becomes smaller. The information communicating part 53 may change at least one of the pitch, loudness, etc., of the sound so that the operator can distinguish each of the size of the horizontal distance in a direction parallel to the longitudinal axis of the upper turning body 3 and the size of the horizontal distance in a direction parallel to the lateral axis of the upper turning body 3. Furthermore, the information communicating part 53 may notify the operator that the position of suspension on the hook 20 is directly above the position of the center of gravity of the suspension load LD by outputting a continuous sound when the horizontal distance is zero. In this case, the information communicating part 53 may automatically stop the continuous sound after outputting the continuous sound over a predetermined time.

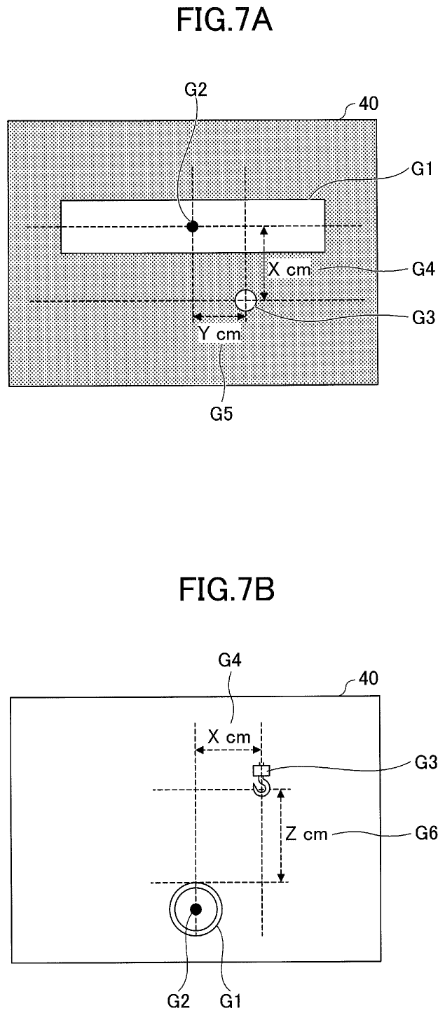

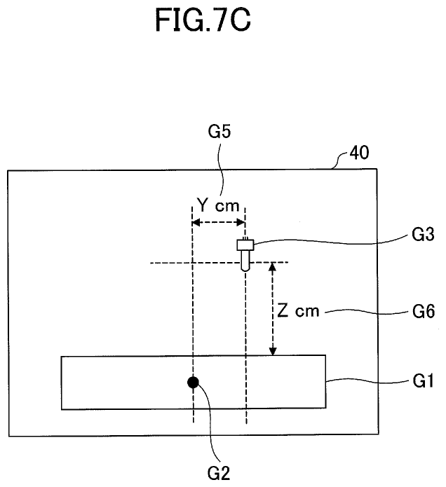

The information communicating part 53 may impart the size of the distance between the position of the center of gravity and the position of suspension using visual information. For example, the information communicating part 53 may notify the operator of the shovel 100 of the size of the distance between the position of the center of gravity and the position of suspension by displaying images as illustrated in FIGS. 7A through 7C. FIGS. 7A through 7C are examples of images displayed on the display device 40 during the execution of the slinging assist process. FIG. 7A illustrates a virtual viewpoint image viewing the hook 20 from directly above. FIG. 7B illustrates a virtual viewpoint image viewing the hook 20 from the left side. FIG. 7C illustrates a virtual viewpoint image viewing the hook 20 from the shovel 100 side. The virtual viewpoint images illustrated n FIGS. 7A through 7B may be generated using an image captured by an image capturing device serving as the object monitoring device S6 or using graphic shapes.

Specifically, the image illustrated in FIG. 7A includes an image G1 of the suspension load LD, an image G2 representing the position of the center of gravity of the suspension load LD, and an image G3 of the hook 20. Furthermore, the image illustrated in FIG. 7A includes an image G4 representing the horizontal distance between the position of the center of gravity of the suspension load LD and the position of suspension on the hook 20 in a direction parallel to the longitudinal axis of the upper turning body 3 and an image G5 representing the horizontal distance between the position of the center of gravity of the suspension load LD and the position of suspension on the hook 20 in a direction parallel to the lateral axis of the upper turning body 3. By operating actuators while looking at the image illustrated in FIG. 7A, the operator of the shovel 100 can move the hook 20 to directly above the suspension load LD while checking the horizontal distance in each of the direction parallel to the longitudinal axis of the upper turning body 3 and the direction parallel to the lateral axis of the upper turning body 3.

The image illustrated in FIG. 7B includes an image G6 representing the vertical distance between the suspension load LD and the position of suspension on the hook 20, in addition to the images G1 through G4. The image G6 may represent the vertical distance between the position of the center of gravity of the suspension load LD and the position of suspension on the hook 20. By operating actuators while looking at the image illustrated in FIG. 7B, the operator of the shovel 100 can move the hook 20 to directly above the suspension load LD while checking the horizontal distance in the direction parallel to the longitudinal axis of the upper turning body 3 and the vertical distance between the suspension load LD and the position of suspension on the hook 20.

The image illustrated in FIG. 7C includes the images G1 through G3, G5 and G6. By operating actuators while looking at the image illustrated in FIG. 7C, the operator of the shovel 100 can move the hook 20 to directly above the suspension load LD while checking the horizontal distance in the direction parallel to the lateral axis of the upper turning body 3 and the vertical distance between the suspension load LD and the position of suspension on the hook 20.

The information communicating part 53 may be configured to display the images illustrated in FIGS. 7A through 7C by switching the images every time a predetermined switch is operated. The information communicating part 53 may automatically switch the image illustrated in FIG. 7A to the image illustrated in FIG. 7C when the horizontal image represented by the image G4 becomes zero. The information communicating part 53 may automatically switch the image illustrated in FIG. 7A to the image illustrated in FIG. 7B when the horizontal image represented by the image G5 becomes zero. The information communicating part 53 may automatically switch the image illustrated in FIG. 7B or 7C to the image illustrated in FIG. 7A when each of the horizontal image represented by the image G4 and the horizontal image represented by the image G5 becomes greater than zero.

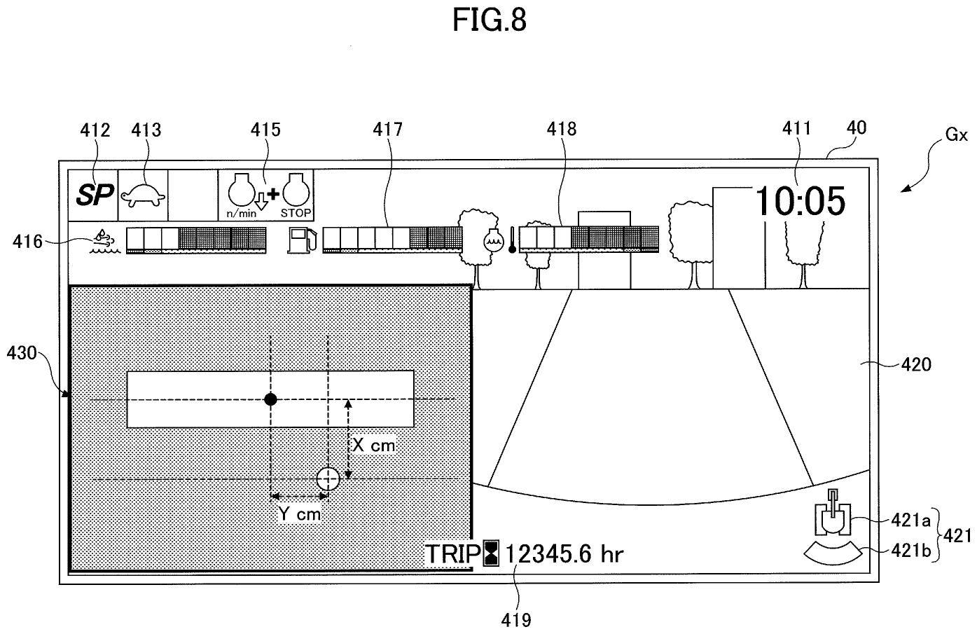

The information communicating part 53 may be configured to display information on the positional relationship between the suspension load LD and the hook 20 along with information on the settings and the operating condition of the shovel 100 as illustrated in FIG. 8. FIG. 8 is an example of an output image Gx displayed on the display device 40. Specifically, the output image Gx includes a time display part 411, a rotational speed mode display part 412, a travel mode display part 413, an engine control status display part 415, a remaining aqueous urea solution amount display part 416, a remaining fuel amount display part 417, a coolant water temperature display part 418, an engine operating time display part 419, a camera image display part 420, and a work guidance display part 430. The rotational speed mode display part 412, the travel mode display part 413, and the engine control status display part 415 are a display part to display information on the settings of the shovel 100. The remaining aqueous urea solution amount display part 416, the remaining fuel amount display part 417, the coolant water temperature display part 418, and the engine operating time display part 419 are a display part to display information on the operating condition of the shovel 100.

The time display part 411 displays a current time. The rotational speed mode display part 412 displays a rotational speed mode set by an engine rotational speed adjustment dial in image form. The travel mode display part 413 displays a travel mode. The engine control status display part 415 displays the control status of the engine 11. The remaining aqueous urea solution amount display part 416 displays the status of the remaining amount of an aqueous urea solution stored in an aqueous urea solution tank in image form. The remaining fuel amount display part 417 displays the status of the remaining amount of fuel stored in a fuel tank. The coolant water temperature display part 418 displays the temperature condition of engine coolant water. The engine operating time display part 419 displays the cumulative operating time of the engine 11.

The camera image display part 420 displays an image captured by an image capturing device serving as the object monitoring device S6. According to the illustration of FIG. 8, an image captured by the back camera S6B is displayed. An image captured by the front camera S6F, the left camera S6L, or the right camera S6R may also be displayed in the camera image display part 420. Images captured by multiple cameras may be displayed side by side or one or more composite images generated from images captured by at least two cameras may be displayed in the camera image display part 420. A composite image may be, for example, an overhead view image as a viewpoint change image.

A graphic shape 421 representing the orientation of an image capturing device that has captured a camera image that is being displayed is displayed in the camera image display part 420. The graphic shape 421 includes a shovel graphic shape 421a representing the shape of the shovel 100 and a strip-shaped direction indicator graphic shape 421b representing the imaging direction of the image capturing device serving as the object monitoring device S6 that has captured the camera image that is being displayed. The graphic shape 421 is a display part to display information on the settings of the shovel 100.

According to the illustration of FIG. 8, the direction indicator graphic shape 421b is displayed below the shovel graphic shape 421a (on the opposite side from the graphic shape of the attachment) to indicate that an image of an area behind the shovel 100 captured by the back camera S6B is displayed in the camera image display part 420.

For example, the operator can switch an image to display in the camera image display part 420 to an image captured by another camera or the like by depressing an image change switch (not depicted) provided in the cabin 10.

The work guidance display part 430 displays guidance information for various kinds of work. According to the illustration of FIG. 8, the image illustrated in FIG. 7A is displayed.

Thus, according to the above-described embodiment, the controller 30 notifies the operator of the shovel 100 of the size of the distance between the suspension load LD and the hook 20 using at least one of the display device 40 and the audio output device 43 provided in the cabin 10. The controller 30, however, may also notify a worker around the shovel 100 of the size of the distance between the suspension load LD and the hook 20. In this case, the controller 30 may transmit information to a multifunctional portable information terminal such as a smartphone carried by the worker. The controller 30 may notify the worker of the size of the distance between the suspension load LD and the hook 20 through at least one of a display device and an audio output device installed in the multifunctional portable information terminal.

Furthermore, the controller 30 may also display the size of the suspension load LD on the display device 40. The size of the suspension load LD is expressed as, for example, at least one of length, width, height and volume.

Furthermore, the controller 30 may determine the type of the suspension load LD based on an image obtained by the object monitoring device S6 and display the determined type of the suspension load LD on the display device 40. The type of the suspension load LD is expressed as, for example, a sandbag, a pipe, a U-shaped gutter, an iron plate, a sheet pile or the like.

Furthermore, the controller 30 may also automatically move the hook 20 to directly above the position of the center of gravity of the suspension load LD. For example, the automatic control part 54 of the machine guidance device 50 may automatically operate at least one of multiple actuators such that the position of suspension on the hook 20 is directly above the position of the center of gravity of the suspension load LD, when a predetermined switch is operated. In this case, the controller 30 may automatically operate at least one of multiple actuators such that the vertical distance between the hook 20 and the suspension load LD becomes a predetermined distance.

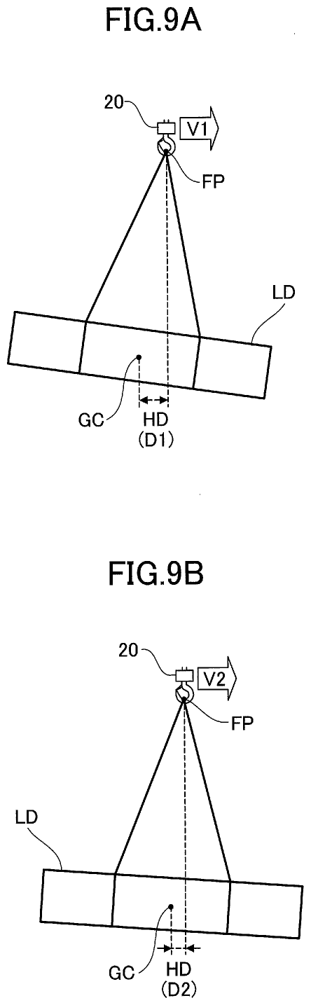

Next, an example of a process that the controller 30 executes when the suspension load LD is suspended is described with reference to FIGS. 9A and 9B. FIGS. 9A and 9B illustrate the state of the suspension load LD suspended from the hook 20 as viewed from the cabin 10 side. Specifically, FIG. 9A illustrates a state where the upper turning body 3 turns clockwise so that the hook 20 moves at a velocity V1. FIG. 9B illustrates a state where the upper turning body 3 turns clockwise so that the hook 20 moves at a velocity V2 lower than the velocity V1. Furthermore, FIG. 9A illustrates a state where a horizontal distance HD between a position of suspension FP on the hook 20 and a position of the center of gravity GC of the suspension load LD is a value D1. Likewise, FIG. 9B illustrates a state where the horizontal distance HD is a value D2 smaller than the value D1. Thus, the horizontal distance HD increases as the movement speed of the hook 20 increases.

The controller 30, for example, controls the movement of the suspension load LD such that the horizontal distance HD is less than or equal to a predetermined threshold by limiting the movement speed of the hook 20. According to this embodiment, when the horizontal distance HD gradually increases to be getting closer to the predetermined threshold, the controller 30 reduces the movement speed of the hook 20, namely, the turning speed of the upper turning body 3, irrespective of the amount of operation of the turning operating lever 26C. For example, by bringing the control valve 173 closer to its neutral position, the controller 30 reduces the flow rate of hydraulic oil flowing into the turning hydraulic motor 2A. Thereafter, when the horizontal distance HD decreases, the controller 30 may increase the moving speed of the hook 20, namely, the turning speed of the upper turning body 3, irrespective of the amount of operation of the turning operating lever 26C, in order to move the suspension load LD with the horizontal distance HD staying at or around the predetermined threshold. Because of this control, the controller 30 can move the suspension load LD while keeping the horizontal distance HD at or below the predetermined threshold.

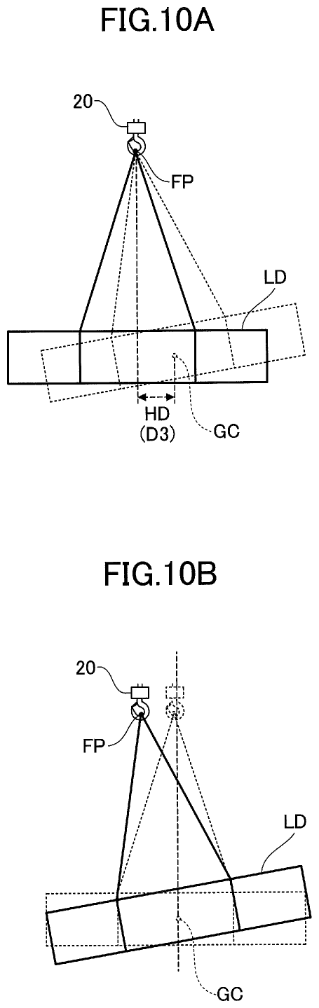

Next, another example of the process that the controller 30 executes when the suspension load LD is suspended is described with reference to FIGS. 10A and 10B. FIGS. 10A and 10B illustrate the state of the suspension load LD suspended from the hook 20 as viewed from the cabin 10 side. Specifically, FIG. 10A illustrates that the suspension load LD keeps moving rightward because of its inertia when the hook 20 stops moving rightward. The dashed line indicates the state of the suspension load LD when the suspension load LD swings. FIG. 10B illustrates that the swing of the suspension load LD is controlled by moving the hook 20 in the swinging direction when the suspension load LD swings. The dashed line indicates the state of the suspension load LD whose swing is controlled and the state of the hook 20 at the time.

The controller 30, for example, controls the swing of the suspension load LD by swiftly moving the hook 20 to directly above the position of the center of gravity GC when the swing occurs. According to this embodiment, when the horizontal distance HD becomes a threshold D3 because of the swing of the suspension load LD, the controller 30 swiftly moves the hook 20 to directly above the position of the center of gravity GC irrespective of the amount of operation of the turning operating lever 26C. For example, by rotating the turning hydraulic motor 2A, the controller 30 turns the upper turning body 3 such that the horizontal distance HD becomes zero. Because of this control, the controller 30 can control the swing of the suspension load LD that occurs, for example, when the hook 20 starts or stops moving, when a strong wind blows, or the like.

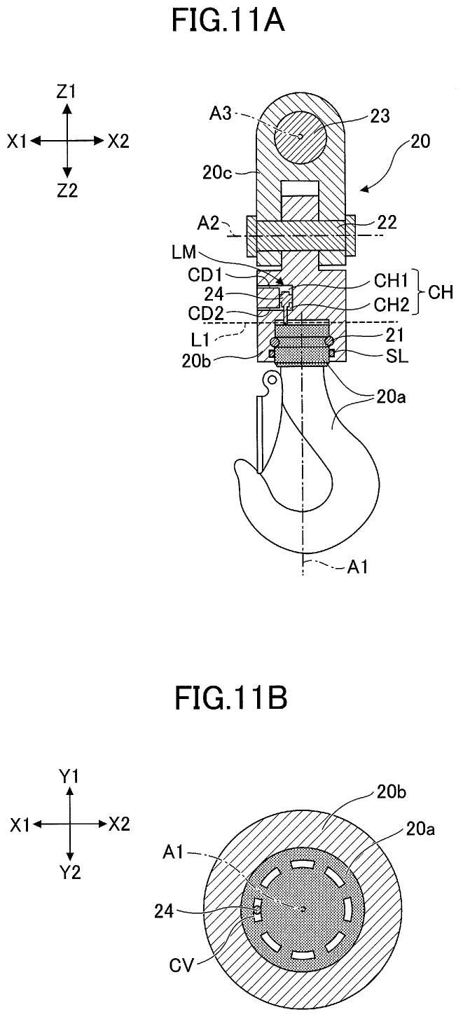

Next, an example configuration of the hook 20 is described with reference to FIGS. 11A and 11B. FIGS. 11A and 11B are diagrams illustrating an example configuration of the hook 20. FIG. 11A illustrates a partial sectional view of the hook 20. FIG. 11B is a sectional view of the hook 20 as seen from the Z1 side, taken along a virtual plane including a line segment L1 of FIG. 11A perpendicular to the Z-axis.

According to the illustration of FIGS. 11A and 11B, the hook 20 includes a body part 20a, a first support part 20b, and a second support part 20c. The body part 20a is so connected to the first support part 20b via multiple balls 21 as to be rotatable about a hook axis A1. The first support part 20b is so connected to the second support part 20c via a pin 22 as to be swingable about an axis A2. The second support part 20c is so connected to the storage part 20S via a pin 23 as to be swingable about an axis A3.

The hook 20 includes a lock mechanism LM that locks rotation about the hook axis A1. The lock mechanism LM is constituted mainly of an oil chamber CH formed in the first support part 20b, a piston 24 placed in the oil chamber CH, and multiple recesses CV formed in the Z1-side end face of the body part 20a. The oil chamber CH includes a first oil chamber CH1 and a second oil chamber CH2. The first oil chamber CH1 is configured to be selectively connected to one of the pilot pump 15 and the hydraulic oil tank via a conduit CD1 and a selector valve (not depicted). The second oil chamber CH2 is configured to be selectively connected to the other of the pilot pump 15 and the hydraulic oil tank via a conduit CD2 and the above-described selector valve. The recesses CV are configured to receive the Z2-side end portion of the piston 24. According to the illustration of FIGS. 11A and 11B, the eight recesses CV are formed at intervals of 45 degrees. The number of the recesses CV, however, may be less than or equal to seven or more than or equal to nine.

The controller 30 may put the lock mechanism LM into a locking state, for example, when a predetermined switch in the cabin 10 is turned on. Specifically, by outputting a control command to the selector valve to put the selector valve into operation, the controller 30 causes hydraulic oil discharged by the pilot pump 15 to flow into the first oil chamber CH1 and causes hydraulic oil in the second oil chamber CH2 to flow out to the hydraulic oil tank. At this point, the piston 24 moves in the Z2 direction to have the Z2-side end portion enter one of the eight recesses CV. As a result, the controller 30 can lock the rotation of the body part 20a about the hook axis A1. An oil seal SL for hermetically sealing hydraulic coil is placed at the connection of the body part 20a and the first support part 20b.

Furthermore, the controller 30 may put the lock mechanism LM into an unlocking state, for example, when the predetermined switch is turned off. Specifically, by outputting a control command to the selector valve to put the selector valve into operation, the controller 30 causes hydraulic oil discharged by the pilot pump 15 to flow into the second oil chamber CH2 and causes hydraulic oil in the first oil chamber CH1 to flow out to the hydraulic oil tank. At this point, the piston 24 moves in the Z1 direction to have the Z2-side end portion exit from the recess CV. As a result, the controller 30 can unlock the rotation of the body part 20a about the hook axis A1.

The lock mechanism LM, which is configured to switch between the locking state and the unlocking state in response to the operation of the predetermined switch according to the illustration of FIGS. 11A and 11B, may also be configured to switch automatically. For example, when an operation to hoist the suspension load LD, such as a boom raising operation, is performed, the controller 30 may automatically switch the lock mechanism LM to the locking state. Furthermore, the controller 30 may also automatically switch the lock mechanism LM to the locking state in response to detecting the removal of the suspension load LD from the hook 20 based on the output of a cylinder pressure sensor or the like. Furthermore, the lock mechanism LM may be manually operated. For example, a worker may switch a locked state and an unlocked state set by the lock mechanism LM by manually switching the position of the selector valve. Furthermore, the lock mechanism LM may also be configured to use a rotation stopper pin that is manually detachable and reattachable, be configured using an electromagnet, or be configured to use the self-weight of the suspension load LD.

As described above, the shovel 100 according to an embodiment of the present invention includes the lower traveling body 1, the upper turning body 3 turnably mounted on the lower traveling body 1, an image capturing device serving as the object monitoring device S6, attached to the upper turning body 3, the attachment attached to the upper turning body 3, the hook 20 attached to the attachment, and the controller 30 serving as a control device, configured to determine whether crane work is performed based on an image captured by the image capturing device serving as the object monitoring device S6 and switch the operating mode to the crane mode in response to determining that crane work is performed. According to this configuration, the shovel 100 can more reliably switch the operating mode to the crane mode when crane work is performed.

The controller 30 may also be configured to switch the operating mode to the crane mode in response to determining that crane work is performed based on the image captured by the image capturing device serving as the object monitoring device S6 and determining that the attachment is in a predetermined posture based on the output of a posture detector. The posture detector includes, for example, at least one of the boom angle sensor S1, the arm angle sensor S2, the bucket angle sensor S3, etc. That is, the controller 30 may be configured to be able to switch the operating mode to the crane mode only when determining that the posture of the attachment is a posture suitable for crane work. According to this configuration, the shovel 100 can prevent erroneously determining that crane work is performed although the posture of the attachment is a posture unsuitable for crane work.

The controller 30 may also be configured to calculate the position of the center of gravity of the suspension load LD based on the image captured by the image capturing device serving as the object monitoring device S6, calculate the position of suspension on the hook 20 based on the output of a position detector, and impart the size of the horizontal distance between the position of the center of gravity and the position of suspension. Because of this configuration, the controller 30 can notify the operator of the shovel 100, a slinging worker, etc., of the size of the horizontal distance between the position of the center of gravity and the position of suspension (hereinafter also referred to as “gravity center misalignment”). Therefore, the controller 30 can prevent slinging from being performed with a large gravity center misalignment, and can prevent the suspension load LD from falling or being significantly inclined when the suspension load LD is lifted. Furthermore, the controller 30 can prevent slinging from being re-performed.

The controller 30 may be configured to impart the size of the horizontal distance between the position of the center of gravity and the position of suspension by displaying the size of the distance on the display device 40. Because of this configuration, the controller 30 can cause the operator of the shovel 100, a slinging worker, etc., to visually recognize at least one of the position of the center of gravity of the suspension load LD, the size of the gravity center misalignment, the direction of the gravity center misalignment, etc. Therefore, the controller 30 can improve work efficiency related to crane work including slinging work.

The controller 30 may be configured to restrict the movement of at least one of the upper turning body 3 and the attachment if the horizontal distance HD exceeds the first threshold D1, when the suspension load LD is suspended as illustrated in FIGS. 9A and 9B, for example. For example, the controller 30 may be configured to reduce the turning speed of the upper turning body 3. Furthermore, the controller 30 may also be configured to automatically operate at least one of the upper turning body 3 and the attachment to reduce the horizontal distance HD if the horizontal distance HD exceeds the second threshold D3, when the suspension load LD is suspended as illustrated in FIGS. 10A and 10B, for example. Because of these configurations, the controller 30 can prevent the swing of the suspension load LD from increasing to an excessive extent. Therefore, the controller 30 can improve the safety and the work efficiency of crane work.

The hook 20 may be configured to rotate about the hook axis A1 and be configured to include the lock mechanism LM that locks rotation about the hook axis A1 as illustrated in FIG. 11A. Because of this configuration, the shovel 100 can prevent the hook 20 from rotating about the hook axis A1 during crane work.

The shovel 100 according to an embodiment of the present invention may also be configured to include the lower traveling body 1, the upper turning body 3 turnably mounted on the lower traveling body 1, the object monitoring device S6 attached to the upper turning body 3, the attachment attached to the upper turning body 3, the hook 20 attached to the attachment, and the controller 30 serving as a control device, configured to determine whether crane work is performed based on information obtained by the object monitoring device S6 and switch the operating mode to the crane mode in response to determining that crane work is performed. Because of this configuration, the controller 30 can more reliably switch the operating mode to the crane mode when crane work is performed.

The controller 30 may also be configured to switch the operating mode to the crane mode in response to determining that crane work is performed based on the information obtained by the object monitoring device S6 and determining that the attachment is in a predetermined posture based on the output of a posture detector.

The controller 30 may also be configured to calculate the position of the center of gravity of the suspension load LD based on the information obtained by the object monitoring device S6, calculate the position of suspension on the hook 20 based on the output of a position detector, and impart the size of the horizontal distance between the position of the center of gravity and the position of suspension.

The controller 30 may also be configured to impart the size of the horizontal distance between the position of the center of gravity and the position of suspension calculated based on the information obtained by the object monitoring device S6 by displaying the size of the horizontal distance on the display device 40 on which an image captured by an image capturing device is displayed.

A preferred embodiment of the present invention is described in detail above. The present invention, however, is not limited to the above-described embodiment. Various variations, replacements, etc., may be applied to the above-described embodiment without departing from the scope of the present invention. Furthermore, the separately described features may be suitably combined as long as causing no technical contradiction.

For example, while a pilot pressure control valve is employed according to the above-described embodiment, a solenoid control valve may also be employed. In this case, the operating apparatus 26 may be an electric operating lever.

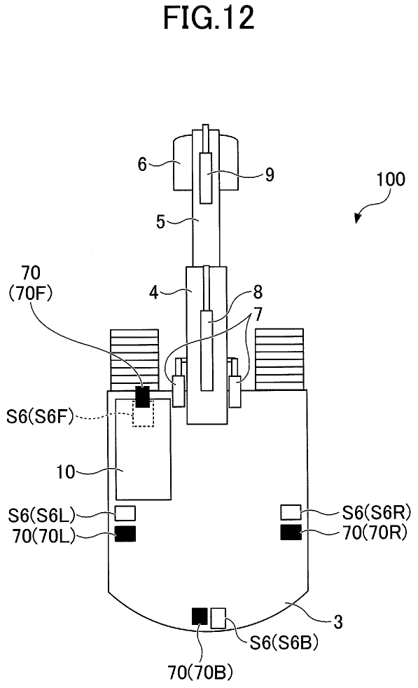

Furthermore, the shovel 100 is configured to include an image capturing device as the object monitoring device S6. The shovel 100, however, may include a space recognition device 70 separately from the image capturing device serving as the object monitoring device S6 as illustrated in FIG. 12. FIG. 12 is a plan view of the shovel 100 including the space recognition device 70.

The space recognition device 70 is configured to be able to detect an object present in a three-dimensional space around the shovel 100. The object is, for example, at least one of a person, an animal, a shovel, a machine, a building, etc. The space recognition device 70 may also be configured to be able to calculate the distance between the space recognition device 70 or the shovel 100 and an object recognized by the space recognition device 70. Examples of the space recognition device 70 include an ultrasonic sensor, a millimeter wave radar, a monocular camera, a stereo camera, a LIDAR, a distance image sensor, and an infrared sensor. According to the example illustrated in FIG. 12, the space recognition device 70 is constituted of a front sensor 70F attached to the front end of the upper surface of the cabin 10, a back sensor 70B attached to the back end of the upper surface of the upper turning body 3, a left sensor 70L attached to the left end of the upper surface of the upper turning body 3, and a right sensor 70R attached to the right end of the upper surface of the upper turning body 3, which are four LIDARs.

The back sensor 70B is placed next to the back camera S6B, the left sensor 70L is placed next to the left camera S6L, and the right sensor 70R is placed next to the right camera S6R. The front sensor 70F is placed next to the front camera S6F across the top plate of the cabin 10. The front sensor 70F, however, may alternatively be placed next to the front camera S6F on the ceiling of the cabin 10.

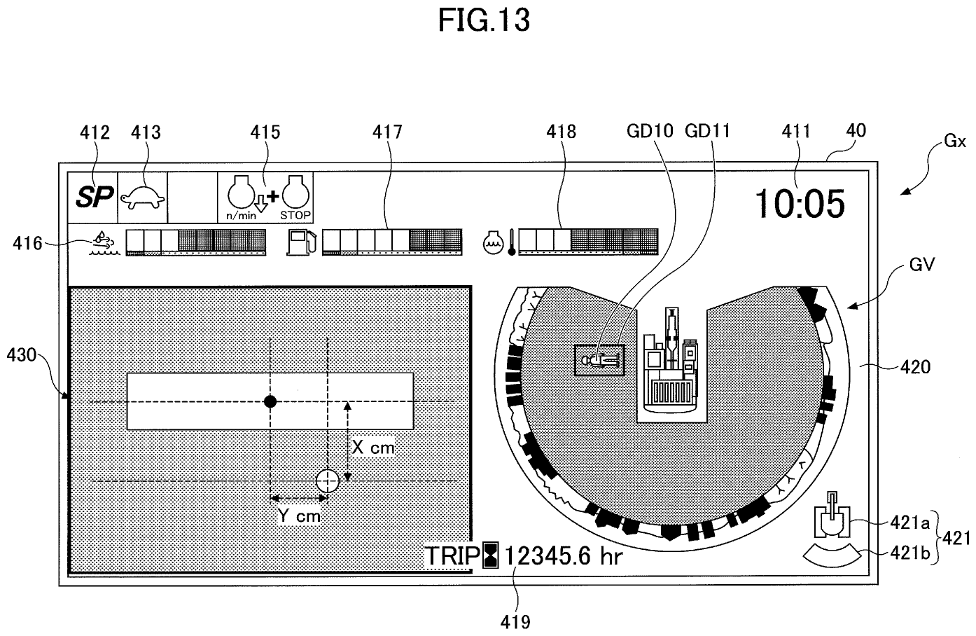

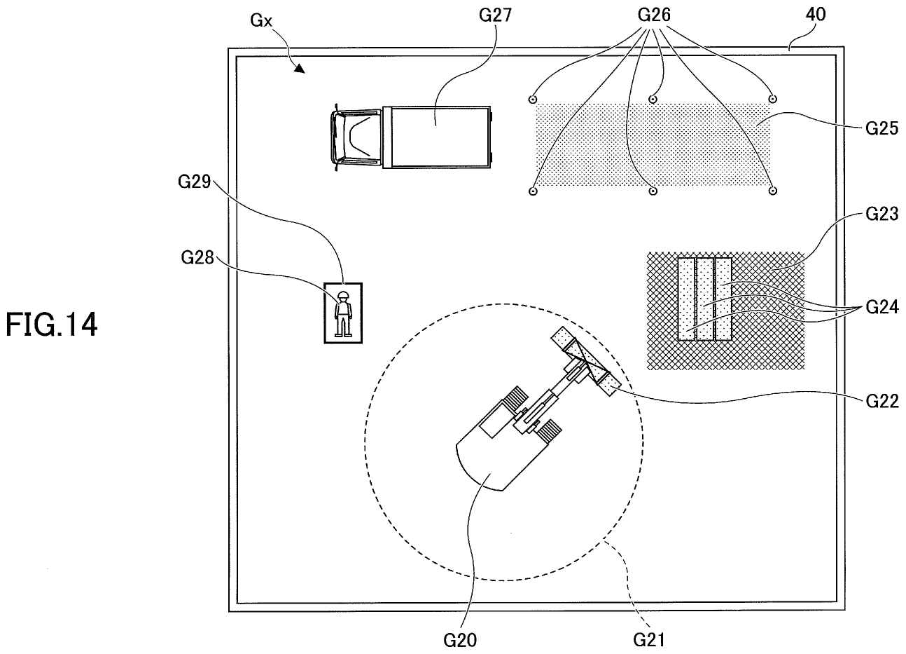

The shovel 100 may be configured to be able to display an overhead view image GV generated by combining the respective output images of the back camera S6B, the left camera S6L, and the right camera S6R on the display device 40 as illustrated in FIG. 13. FIG. 13 illustrates another example of the layout of the output image Gx displayed on the display device 40. The output image Gx of FIG. 13 is different in that the overhead view image GV is displayed in the camera image display part 420 from, but otherwise equal to, the output image Gx of FIG. 8.

Specifically, the output image Gx of FIG. 13 includes an image GD11 for highlighting an image GD10 of an object (person) detected by the space recognition device 70. The shovel 100 identifies a portion of the overhead view image GV at which the image GD10 of the object (person) detected by the space recognition device 70 is present based on the output of the space recognition device 70, and displays the identified portion with highlighting so that the operator can distinguish the identified portion from other portions.

According to the example of FIG. 13, the image GD11 is an image of a frame surrounding the image GD10 of the objected (person) detected by the space recognition device 70. The image GD11, however, may alternatively be an image of an arrow pointing at the image GD10 of the object or an image other than a frame and an arrow. Furthermore, the shovel 100 may cause the image GD11 to blink. The shovel 100 may also change at least one of the luminance, color, etc., of a portion corresponding to the image GD11 so that the portion corresponding to the image GD11 stands out from its surrounding portion.

Thus, the shovel 100 can display a portion including an image of the object detected by the space recognition device 70 with highlighting so that the operator of the shovel 100 can be easily aware of the presence of the object. Therefore, the operator of the shovel 100 can be aware of the presence of the object by looking at an image displayed on the display device 40 when performing crane work or the like.

Furthermore, according to the above-described embodiment, the shovel 100 is configured to determine whether crane work is performed based on an image captured by an image capturing device serving as the object monitoring device S6 and switch the operating mode to the crane mode in response to determining that crane work is performed. Similarly to this configuration, the shovel 100 may also be configured to determine whether slinging work is being performed based on the output of at least one of the image capturing device, the space recognition device 70, etc., and disable one or more or all of the operating apparatus 26 in response to determining that slinging work is being performed. The disabled state means a state where a corresponding actuator does not operate even when the operating apparatus 26 is operated. According to this configuration, the shovel 100 may switch the enabled state of the disabled state of the operating apparatus 26 using, for example, a solenoid valve (not depicted) that can open and close a conduit connecting the control valve 17 and the operating apparatus 26. This is for preventing the shovel 100 from accidentally starting to move because of an accidental operation of the operating apparatus 26 while slinging work is being performed. Specifically, in response to determining that slinging work is being performed, the shovel 100 may disable at least one of the boom operating lever, the arm operating lever, the bucket operating lever, the turning operating lever, the travel operating lever, and the travel operating pedal of the operating apparatus 26. For example, the shovel 100 may disable only the turning operating lever in response to determining that slinging work is being performed.

Furthermore, in response to detecting an object within a predetermined distance range from the shovel 100 when the crane mode is selected, the shovel 100 may disable at least one of the boom operating lever, the arm operating lever, the bucket operating lever, the turning operating lever, the travel operating lever, and the travel operating pedal of the operating apparatus 26. This is for ensuring prevention of the contact between the suspension load LD and the object.

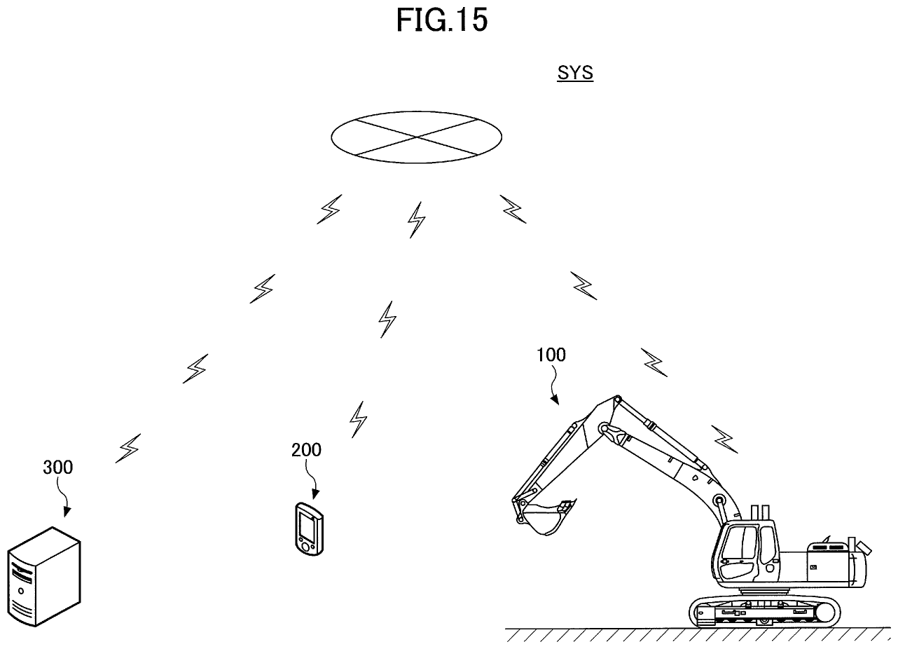

The shovel 100 may also be configured to display the output image Gx that shows the situation of a construction site on the display device 40 as illustrated in FIG. 14. FIG. 14 illustrates another example of the layout of the output image Gx displayed on the display device 40.

The output image Gx of FIG. 14 expresses the situation of a construction site using graphic shapes. The output image Gx of FIG. 14, however, may be at least partly generated by combining an image obtained by an image capturing device serving as the object monitoring device S6 or generated by combining an image obtained by an image capturing device attached to a steel tower or a building installed in the construction site. Furthermore, the output image Gx of FIG. 14, which is displayed full screen on the display device 40, may be displayed in the camera image display part 420 in the output image Gx of FIG. 13.

The display position of each graphic shape may be, for example, determined based on the output of at least one of the positioning device P1, the object monitoring device S6, the space recognition device 70, etc., or determined based on information on the construction site stored in the storage device 47. The information on the construction site includes, for example, information on the position and range of a no-entry area, a material yard, a construction vehicle passage, etc. The display position of each graphic shape may also be determined based on information from a communications device installed outside the shovel 100, such as a communications device mounted on a dump truck, or the like.

Specifically, the output image Gx of FIG. 14 includes a shovel graphic shape G20, a turning range graphic shape G21, a suspension load graphic shape G22, a material yard graphic shape G23, a material graphic shape G24, a no-entry area graphic shape G25, a road cone graphic shape G26, a dump truck graphic shape G27, a worker graphic shape G28, and a frame graphic shape G29.

The shovel graphic shape G20 is a graphic shape representing the shovel 100. Desirably, the shovel graphic shape G20 is displayed in such a manner as to change according as the shovel 100 moves. For example, a portion of the shovel graphic shape G20 corresponding to an excavation attachment may be so displayed as to extend when the actual excavation attachment extends.

The turning range graphic shape G21 is a graphic shape representing the size of the current turning range of the shovel 100. The turning range is, for example, a range represented by a circle whose turning radius is the distance between the end of the excavation attachment and the turning axis in a direction along the longitudinal axis of the upper turning body 3. Desirably, the turning range graphic shape G21 is displayed in such a manner as to increase as the actual excavation attachment extends.

The suspension load graphic shape G22 is a graphic shape representing the suspension load LD that the shovel 100 is hoisting. According to the illustration of FIG. 14, the suspension load graphic shape G22 is a graphic shape of a pipe that the shovel 100 is hoisting.

The material yard graphic shape G23 is a graphic shape representing a material yard that is a place where materials such as pipes are temporarily placed. According to the illustration of FIG. 14, the material yard graphic shape G23 is represented by a cross hatch.

The material graphic shape G24 is a graphic shape representing materials temporarily placed in the material yard. According to the illustration of FIG. 14, the material graphic shape G24 is a graphic shape of three pipes that are already temporarily placed in the material yard.

The no-entry area graphic shape G25 is a graphic shape representing an area that the shovel 100 is restricted from entering. According to the illustration of FIG. 14, the no-entry area graphic shape G25 is represented by a dot hatch. The no-entry area is, for example, an area surrounded by road cones. Typically, in the no-entry area, various kinds of work are performed by workers or the like. For example, in response to detecting road cones based on the output information of at least one of the object monitoring device S6, the space recognition device 70, etc., the shovel 100 may recognize an area surrounded by the road cones as a no-entry area.

The road cone graphic shape G26 is a graphic shape representing a road cone. According to the illustration of FIG. 14, the road cone graphic shape G26 represents six road cones surround the no-entry area.

The dump truck graphic shape G27 is a graphic shape representing a dump truck that has entered the construction site. The display position of the dump truck graphic shape G27 may be determined based on, for example, the output information of at least one of the object monitoring device S6, the space recognition device 70, etc. The display position of the dump truck graphic shape G27 may also be determined based on the output of a positioning device mounted on the dump truck.

The worker graphic shape G28 is a graphic shape representing a worker working in the construction site. The display position of the worker graphic shape G28 may be determined based on, for example, the output information of at least one of the object monitoring device S6, the space recognition device 70, etc. The display position of the worker graphic shape G28 may also be determined based on position information output by an assist device such as a smartphone carried by the worker.

The frame graphic shape G29 is a graphic shape highlighting the presence of a worker. According to the illustration of FIG. 14, the frame graphic shape G29 is a rectangular frame surrounding the worker graphic shape G28. The frame graphic shape G29 may be so displayed as to blink.

The display position of the material yard graphic shape G23 may be determined through the input device 42. For example, the operator of the shovel 100 may select a desired position and range within the output image Gx as the display position of the material yard graphic shape G23 through a touch input to a touchscreen serving as the input device 42 while looking at the output image Gx displayed on the display device. This is for causing the controller 30 to recognize a material yard serving as a place onto which the suspension load LD is lowered.

In this case, the controller 30 may automatically or semi-automatically operate an actuator in order to move a material to the material yard. For example, after the wire WR (the suspension load LD) is slung onto the hook 20, the controller 30 may automatically or semi-automatically operate at least one of the turning hydraulic motor 2A, the boom cylinder 7, the arm cylinder 8, and the bucket cylinder 9 in order to lift the suspension load LD. Then, the controller 30 may automatically or semi-automatically rotate the left traveling hydraulic motor 1L and the right traveling hydraulic motor 1R to cause the shovel 100 to travel to the material yard. Then, the controller 30 may automatically or semi-automatically operate at least one of the turning hydraulic motor 2A, the boom cylinder 7, the arm cylinder 8, and the bucket cylinder 9 to operate the shovel 100 such that the suspension load LD is lowered onto an appropriate location in the material yard. After the suspension load LD is lowered onto an appropriate location in the material yard, a slinging worker may remove the wire WR (the suspension load LD) hung on the hook 20 from the hook 20. In the case of automatically operating the shovel 100 with the suspension load LD being hoisted, the controller 30 may execute processes to control a swing of the suspension load LD as described with reference to FIGS. 9A through 10B.

Furthermore, the display device 40 may display information on crane work. The information on crane work includes, for example, at least one of an image related to crane work, a time at which crane work was performed, the type, size, weight, and position of the center of gravity of the suspension load LD, information on the occurrence of a dangerous situation, etc. The type (use) of the suspension load LD is expressed as, for example, a sandbag, a pipe, a U-shaped gutter, an iron plate, a sheet pile or the like. The size of the suspension load LD is expressed as, for example, at least one of length, width, height and volume. The controller 30 may calculate the weight of the suspension load LD based on, for example, the posture of the attachment, the pressure of hydraulic oil in the bottom-side oil chamber of the boom cylinder 7 (boom bottom pressure), and the pre-recorded specifications (weight, the position of the center of gravity, etc.) of the attachment. Specifically, the controller 30 may calculate the weight of the suspension load LD based on the outputs of information obtaining devices including the boom angle sensor S1, the arm angle sensor S2, and a boom bottom pressure sensor.

The image related to crane work may be either a still image or video. The information on the occurrence of a dangerous situation includes, for example, the performance of hoisting with the horizontal distance between the position of suspension on the hook 20 and the position of the center of gravity of the suspension load LD exceeding a predetermined distance.

Information obtained by the shovel 100 may be shared with a manager, other shovel operators, etc., through a shovel management system SYS as illustrated in FIG. 15. FIG. 15 is a schematic diagram illustrating an example configuration of the shovel management system SYS. The management system SYS is a system that manages the shovel 100. According to this embodiment, the management system SYS is constituted mainly of the shovel 100, an assist device 200, and a management apparatus 300. Each of the shovel 100, the assist device 200, and the management apparatus 300 constituting the management system SYS may be one or more in number. According to the illustration of FIG. 15, the management system SYS includes the single shovel 100, the single assist device 200, and the single management apparatus 300.

The assist device 200 is typically a portable terminal device, and is, for example, a computer such as a notebook PC, a tablet PC, or a smartphone carried by a worker or the like at a construction site. The assist device 200 may also be a computer carried by the operator of the shovel 100. The assist device 200, however, may also be a stationary terminal device.

The management apparatus 300 is typically a stationary terminal device, and is, for example, a server computer installed in a management center or the like outside a construction site. The management apparatus 300 may also be a portable computer (for example, a portable terminal device such as a notebook PC, a tablet PC, or a smartphone).

According to the management system SYS of FIG. 15, the shovel 100 transmits information on a construction site obtained using at least one of the positioning device P1, the object monitoring device S6, the space recognition device 70, etc., to at least one of the assist device 200 and the management apparatus 300. The information on a construction site includes, for example, at least one of information on crane work and information on an object detected by the space recognition device 70.

The information on crane work includes, for example, at least one of an image related to crane work, a time at which crane work was performed, the type, size, weight, and position of the center of gravity GC of the suspension load LD, information on the occurrence of a dangerous situation, etc. The image related to crane work may be either a still image or video. The information on the occurrence of a dangerous situation includes, for example, the performance of hoisting with the horizontal distance between the position of suspension on the hook 20 and the position of the center of gravity of the suspension load LD exceeding a predetermined distance. The information on an object includes, for example, at least one of the image, size, type, and position of the object, the distance between the object and the shovel 100, etc.

At least one of the assist device 200 and the management apparatus 300 that have received the information on a construction site displays an image related to a construction site on the attached display device 40. The image related to a construction site is typically an image as illustrated in FIG. 14. Therefore, a worker who uses the assist device 200, a manager who uses the management apparatus 300, or the like can see the same output image as the output image Gx that the operator of the shovel 100 sees on the display device 40.

Furthermore, the information on a construction site is not limited to information obtained by at least one of the positioning device P1, the object monitoring device S6, the space recognition device 70, etc., and may also be information that a worker inputs through the assist device 200 or the like. In this case, the information input through the assist device 200 may be transmitted to at least one of the shovel 100 and the management apparatus 300 through radio communications.

Based on the above-described configuration, the management system SYS enables a user who uses the management system SYS, such as an operator, a worker or a manager outside the shovel 100, to check the information on a construction site.

Therefore, even when the shovel 100 is provided as a remotely controllable shovel, a user who uses the management system SYS can easily understand the situation of a construction site when remotely controlling the shovel 100.

The management apparatus 300 may, for example, manage a workload based on the received information on crane work. Specifically, the management apparatus 300 may record the total amount of suspension loads LD carried by a day's crane work as the workload of the day.

The shovel 100 may also be configured to, when such a travel operation, a turning operation or the like as to move the shovel 100 toward an object detected by the space recognition device 70, transmit, in addition to the information on the object, information on the operator of the shovel 100, information on the operation of the shovel 100, information on the condition of the shovel 100, etc., to at least one of the assist device 200 and the management apparatus 300. This is for enabling a manager or the like to conduct an ex post analysis of the reason the operation to move the shovel 100 toward the object has been performed.

For example, by remotely controlling the shovel 100 manually, the operator of the shovel 100 can perform a series of operations including the operation of hanging the wire WR on the hook 20, the operation of checking the state of the hung wire WR by slightly moving up the hook 20 (the bucket 6), and the operation of adjusting the distance between the position of suspension on the hook 20 and the position of the center of gravity of the suspension load LD without returning into the cabin 10. Specifically, a worker can move the shovel 100 at a position distant from the shovel 100, using the assist device 200.

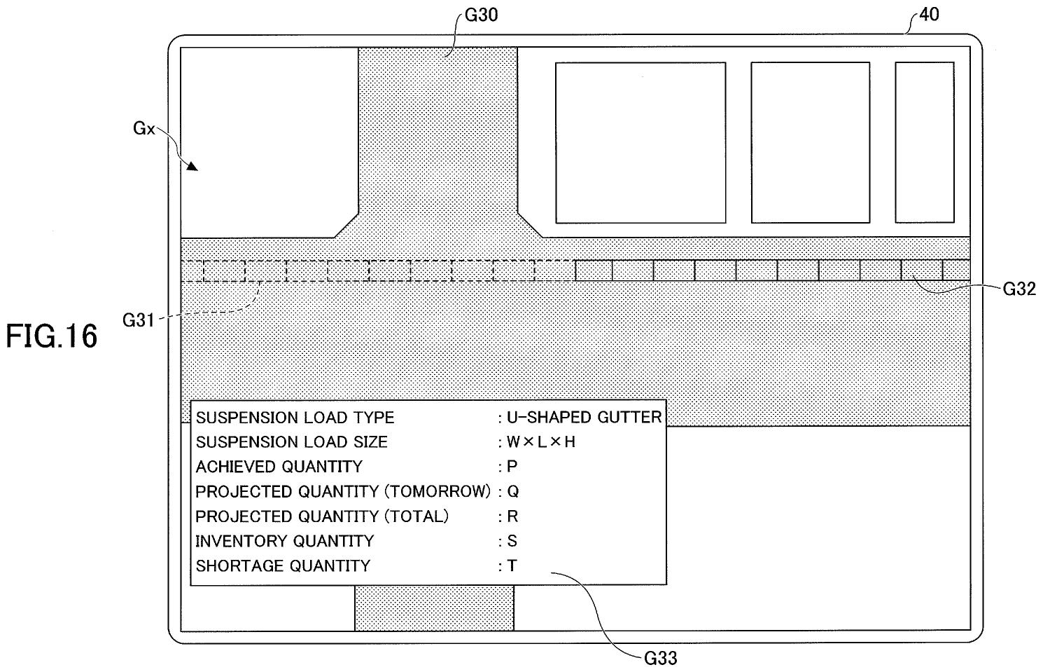

As illustrated in FIG. 16, the management apparatus 300 may also be configured to be able to display the output image Gx showing work progress on the display device 40 attached to the management apparatus 300. FIG. 16 illustrates an example of the layout of the output image Gx displayed on the display device 40 attached to the management apparatus 300.

The output image Gx of FIG. 16 expresses progress in the burial work of U-shaped gutters using graphic shapes. The output image Gx of FIG. 16, however, may be at least partly generated by combining an image obtained by an image capturing device serving as the object monitoring device S6 or generated by combining an image obtained by an image capturing device attached to a steel tower or a building installed in a construction site. Furthermore, the output image Gx of FIG. 16, which is displayed full screen on the display device 40, may be displayed in the camera image display part 420 in the output image Gx of FIG. 13.

The display position of each graphic shape in the output image Gx may be, for example, determined based on the output of at least one of the positioning device P1, the object monitoring device S6, the space recognition device 70, etc., or determined based on information on a construction site stored in the storage device 47. The information on a construction site includes, for example, information on the position and range of an already buried U-shaped gutter and the position and range of the projected burial of a U-shaped gutter.

Specifically, the output image Gx of FIG. 16 includes a road graphic shape G30, a graphic shape G31 of a U-shaped gutter yet to be provided, a graphic shape G32 of a U-shaped gutter already provided, and an information window G33.

The road graphic shape G30 is a graphic shape representing a road. The graphic shape G31 is a graphic shape representing a U-shaped gutter yet to be provided that is a U-shaped gutter to be buried. The graphic shape G32 is a graphic shape representing a U-shaped gutter already provided that is a U-shaped gutter already buried.

The information window G33 is a field where information on crane work is displayed. According to the illustration of FIG. 16, the information on crane work includes the type of a suspension load, the size of a suspension load, an achieved quantity, a projected quantity (tomorrow), a projected quantity (total), an inventory quantity, and a shortage quantity.

The achieved quantity represents the number of U-shaped gutters hoisted and buried by crane work. The projected quantity (tomorrow) represents the number of U-shaped gutters yet to be provided to be hoisted and buried by the next day's crane work. The projected quantity (total) represents the number of U-shaped gutters yet to be provided to be hoisted and buried by crane work by the completion of construction. The inventory quantity represents the number of U-shaped gutters yet to be provided that are temporarily placed in a material yard. The shortage quantity represents the number of U-shaped gutters that need to be ordered, that is, a number obtained by subtracting the inventory number from the projected number (total).

Specifically, the information window G33 shows that the type of a suspension load is a “U-shaped gutter,” that the size (length, width, and height) of a suspension load is “W×L×H,” that the achieved quantity is “P,” that the projected quantity (tomorrow) is “Q,” that the projected quantity (total) is “R,” that the inventory quantity is “S,” and that the shortage quantity is “T.”

To display the output image Gx as illustrated in FIG. 16, the management apparatus 300 is configured to store information on crane work after the operating mode of the shovel 100 is switched to the crane mode and position information associated with a construction site in correlation with each other.

The position information associated with a construction site includes, for example, information on the location of a construction site. Because of this configuration, the management apparatus 300 can make collective progress management of multiple construction sites.

The position information associated with a construction site may include information on the burial position of a U-shaped gutter in a construction site. The information on the burial position of a U-shaped gutter includes, for example, information on the burial position of each of U-shaped gutters to be buried. Because of this configuration, the management apparatus 300 can manage progress in a particular construction site in detail.

The output image Gx, which is configured to display progress in the burial work of U-shaped gutters according to FIG. 16, may also be configured to display progress in other crane work construction such as stacking sandbags, installing a sheet pile, burying a pipe, or laying an iron plate.

For example, the output image Gx may be configured to display progress in construction involving crane work for carrying a soil improver onto the muddy ground. In this case, the information on crane work includes at least one of: the type of a soil improver; the amount of a soil improver necessary per unit volume of the muddy ground; the weight of a single soil improver; the number of times a soil improver is carried; the size (area) of a land whose soil is improved; the quantity of a soil improver to be used; the quantity of a soil improver used; the quantity of a soil improver in inventory; the quantity of shortage of a soil improver, etc.

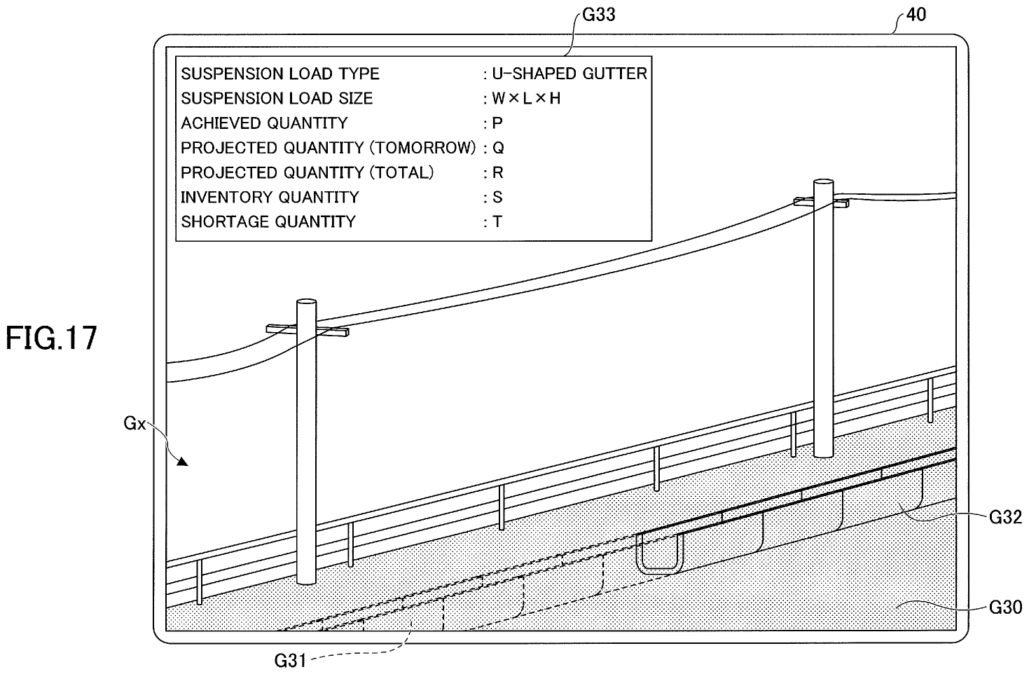

The management apparatus 300 may also be configured to display another output image Gx showing progress in construction on the display device 40 attached to the management apparatus 300 as illustrated in FIG. 17. FIG. 17 illustrates another example of the layout of the output image Gx displayed on the display device 40 attached to the management apparatus 300.

The same as the output image Gx of FIG. 16, the output image Gx of FIG. 17 expresses progress in the burial work of U-shaped gutters using graphic shapes. The output image Gx of FIG. 17, however, may be at least partly generated by combining an image obtained by an image capturing device serving as the object monitoring device S6 or generated by combining an image obtained by an image capturing device attached to a steel tower or a building installed in a construction site. Furthermore, the output image Gx of FIG. 17, which is displayed full screen on the display device 40, may be displayed in the camera image display part 420 in the output image Gx of FIG. 13.

The output image Gx of FIG. 17 is different in expressing a construction site in perspective (a perspective view) from the output image Gx of FIG. 16, which expresses a construction site in a plan view. The management apparatus 300 may generate the output image Gx of FIG. 17 by, for example, displaying information on crane work over an image created using 3D-CAD. The management apparatus 300 may also generate the output image Gx of FIG. 17 by displaying information on crane work over an image obtained by the object monitoring device S6 mounted on an aerial vehicle such as a drone or a multicopter.

Because of the above-described configuration, the management apparatus 300 can cause the manager to easily understand progress in the burial work of U-shaped gutters. The manager who looks at the output image Gx can immediately and intuitively understand progress in the burial work of U-shaped gutters.

According to the management system SYS, the shovel 100 may be configured to switch the operating mode to the crane mode based on information obtained by the object monitoring device S6 and correlate information on crane work after the switching with position information associated with a construction site. In this case, the management apparatus 300 may be configured to update information on progress in construction based on the information on crane work and the position information associated with a construction site received from the shovel 100.

Specifically, when crane work for installing a U-shaped gutter has been performed, the shovel 100 correlates information on the type of a suspension load and information on a position (such as position coordinates) where this crane work has been performed and transmits the information to the management apparatus 300. The management apparatus 300 determines that a U-shaped gutter has been installed at a location indicated by the received position coordinates based on the received information, and updates the information on progress in construction based on this determination result.

Furthermore, the management apparatus 300 may have information on crane work at a time that is prior to receiving information from the shovel 100. In this case, the information on progress in construction may be updated based on the information on crane work correlated with the position information received from the shovel 100, in contrast to the information on crane work at the time that is prior to receiving information from the shovel 100.

Specifically, when having information that the achieved quantity of U-shaped gutters installed in a work site is one at the time that is prior to receiving information from the shovel 100, the management apparatus 300 updates the achieved quantity of U-shaped gutters installed in the work site to two in response to receiving information that another U-shaped gutter has been installed in the work site from the shovel 100. At this point, the management apparatus 300 may update the display of the graphic shape G31 of a U-shaped gutter yet to be provided and the graphic shape G32 of a U-shaped gutter already provided and the display of the achieved quantity, etc., in the information window G33 in each of FIGS. 16 and 17. More specifically, when updating the display of the graphic shape of a U-shaped gutter, the management apparatus 300 switches the graphic shape G31 of a U-shaped gutter yet to be provided indicated by a dashed line corresponding to the received position information to the graphic shape G32 of a U-shaped gutter already provided indicated by a solid line.

What is claimed is:

1. A shovel comprising:
a lower traveling body;
an upper turning body turnably mounted on the lower traveling body;
an object monitoring device attached to the upper turning body;
an attachment attached to the upper turning body;
a hook attached to the attachment; and
a hardware processor configured to switch an operating mode of the shovel to a crane mode based on information obtained by the object monitoring device.

2. The shovel as claimed in claim 1, further comprising:
a posture detector configured to detect a posture of the attachment,
wherein the hardware processor is configured to switch the operating mode to the crane mode in response to determining that crane work is performed based on the information obtained by the object monitoring device and determining that the attachment is in a predetermined posture based on an output of the posture detector.

3. The shovel as claimed in claim 2, wherein the hardware processor is configured to
calculate a position of a center of gravity of a suspension load based on the information obtained by the object monitoring device,
calculate a position of suspension on the hook based on the output of the posture detector, and
impart a size of a horizontal distance between the position of the center of gravity and the position of suspension.

4. The shovel as claimed in claim 3, further comprising:
a display device in a cabin provided on the upper turning body,
wherein the hardware processor is configured to impart the size of the horizontal distance by displaying the size of the horizontal distance on the display device.

5. The shovel as claimed in claim 3, wherein the hardware processor is configured to restrict a movement of at least one of the upper turning body and the attachment when the horizontal distance exceeds a first threshold during suspension of the suspension load.

6. The shovel as claimed in claim 3, wherein the hardware processor is configured to reduce the horizontal distance by automatically operating at least one of the upper turning body and the attachment when the horizontal distance exceeds a second threshold during suspension of the suspension load.

7. The shovel as claimed in claim 1, wherein the hook is configured to rotate about a hook axis, and includes a lock mechanism configured to lock a rotation of the hook about the hook axis.

8. A shovel management system comprising:
a shovel including a hardware processor configured to switch an operating mode of the shovel to a crane mode based on information obtained by an object monitoring device; and
a management apparatus configured to store information on crane work after the operating mode is switched to the crane mode and position information associated with a construction site in correlation with each other.

9. A shovel management system comprising:
a shovel configured to switch an operating mode of the shovel to a crane mode based on information obtained by an object monitoring device and correlate information on crane work after the switching and position information associated with a construction site with each other; and
a management apparatus configured to update information on progress based on the information on the crane work and the position information associated with the construction site received from the shovel.

10. The shovel management system as claimed in claim 9, wherein
the management apparatus has information on the crane work at a time that is prior to receiving the information from the shovel, and
the information on the progress is updated based on the information on the crane work correlated with the position information received from the shovel, in contrast to the information on the crane work at the time that is prior to said receiving.
